(19) United States
(12) Patent Application Publication
(10) Pub. No.: US 2015/0117896 A1
(43) Pub. Date: Apr. 30, 2015

(54) CLEANING BLADE AND IMAGE FORMING APPARATUS INCLUDING SAME

(71) Applicants: Naomi SUGIMOTO, Kanagawa (JP); Yoshiki Hozumi, Kanagawa (JP); Yohta Sakon, Kanagawa (JP); Shinji Nohsho, Tokyo (JP); Masanobu Gondoh, Kanagawa (JP); Masahiro Ohmori, Kanagawa (JP); Shohei Gohda, Kanagawa (JP); Yuka Aoyama, Kanagawa (JP); Kaori Toyama, Kanagawa (JP)

(72) Inventors: Naomi SUGIMOTO, Kanagawa (JP); Yoshiki Hozumi, Kanagawa (JP); Yohta Sakon, Kanagawa (JP); Shinji Nohsho, Tokyo (JP); Masanobu Gondoh, Kanagawa (JP); Masahiro Ohmori, Kanagawa (JP); Shohei Gohda, Kanagawa (JP); Yuka Aoyama, Kanagawa (JP); Kaori Toyama, Kanagawa (JP)

(21) Appl. No.: 14/512,711

(22) Filed: Oct. 13, 2014

(30) Foreign Application Priority Data
Oct. 31, 2013 (JP) 2013-227416
Sep. 17, 2014 (JP) 2014-189005

(51) Int. Cl. G03G 15/16; G03G 21/00

(52) U.S. Cl. CPC G03G 15/161
USPC 399/101; 399/350

(57) ABSTRACT

A cleaning blade for an image forming apparatus includes a base and a contact portion disposed on the base that contacts and cleans a surface of an intermediate transfer belt. A Martens hardness of the contact portion of the cleaning blade is at least 2 [N/mm²] and not more than 10 [N/mm²].

### CROSS-REFERENCE TO RELATED APPLICATIONS

The present application claims priority pursuant to 35 U.S.C. §119(a) from Japanese patent application numbers 2013-227416, and 2014-189005, filed on Oct. 31, 2013, and Sep. 17, 2014, the entire disclosures of which are incorporated by reference herein.

### BACKGROUND

1. Technical Field

Exemplary embodiments of the present invention relate to a cleaning blade and an image forming apparatus including the cleaning blade.

2. Background Art

Conventionally, image forming apparatuses, such as printers, facsimile machines, copiers, and multifunction apparatuses including several capabilities of these devices and employing an intermediate transfer method are known, in which a toner image formed on a photoreceptor is primarily transferred onto an intermediate transfer belt and the toner image thus transferred onto the intermediate transfer belt is secondarily transferred onto a recording medium or sheet. In the image forming apparatus employing such an intermediate transfer method, residual toner remaining on the intermediate transfer belt without being transferred onto the recording sheet is removed with a cleaning blade built into the apparatus.

In general, an image forming apparatus employing the intermediate transfer method is configured to form a density detection pattern on the intermediate transfer belt to obtain a stable image density constantly; cause the density pattern on the intermediate transfer belt to be detected by an optical sensor; and adjust image forming conditions such as developing potential based on detection results. It is preferred that the intermediate transfer belt be formed by projection molding because of its ease of manufacture and its reduced cost. However, an intermediate transfer belt formed by projection molding has a problem in that a film of paper dust tends to adhere to a surface of the intermediate transfer belt, interfering with accurate optical sensor detection and thus hindering correction of image forming conditions.

It is understood that the main component of paper dust is calcium carbonate, which sticks to the surface of the intermediate transfer belt and cannot be removed by an ordinary cleaning blade made of common urethane rubber having Martens hardness of 0.5 [N/mm²].

Thus, the present invention aims to provide a cleaning blade that can remove paper dust attached to the intermediate transfer belt, and an image forming apparatus including the same.

### SUMMARY

In one embodiment of the disclosure, there is provided an improved cleaning blade for use in an image forming apparatus, including a base and a contact portion disposed on the base that contacts and cleans a surface of an intermediate transfer belt. A Martens hardness of the contact portion of the cleaning blade is at least 2 [N/mm²] and not more than 10 [N/mm²].

In another embodiment of the disclosure, there is provided an improved image forming apparatus that includes an image carrier; an intermediate transfer belt; a toner image forming unit to form a toner image on the image carrier; a primary transfer unit to transfer the toner image formed on the image carrier to the intermediate transfer belt; a secondary transfer unit to transfer the toner image carried on the intermediate transfer belt to a recording sheet; and a cleaning blade including a base and a contact portion disposed on the base that contacts and cleans a surface of the intermediate transfer belt. A Martens hardness of the contact portion of the cleaning blade is at least 2 [N/mm²] and not more than 10 [N/mm²].

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 illustrates a general configuration of a printer according to an embodiment of the present invention;

FIG. 2 is a graph illustrating Vsg fluctuations of an intermediate transfer belt α made of PI formed by centrifugal molding along a peripheral length of 100 mm;

FIG. 3 is a graph illustrating Vsg fluctuations of an intermediate transfer belt β made of PPS formed by extrusion molding along a peripheral length of 100 mm;

FIG. 4 is a graph illustrating mirror reflection output measured by an optical sensor of a gray scale pattern formed of 10 toner patches of different densities formed on the intermediate transfer belt α;

FIG. 5 is a graph illustrating mirror reflection output measured by an optical sensor of a gray scale pattern including 10 toner patches of different densities formed on the intermediate transfer belt β;

FIG. 6 is a graph illustrating readings of Martens hardness of the intermediate transfer belt and If rate of increase;

FIG. 7 illustrates a schematic configuration of a cleaning blade according to an embodiment of the present invention;

FIG. 8 illustrates a state of contact between the cleaning blade and the intermediate transfer belt;

FIG. 9 is a graph illustrating readings of Martens hardness of the intermediate transfer belt and If rate of increase of a cleaning blade #1;

FIG. 10 is a graph illustrating readings of Martens hardness of the intermediate transfer belt and If rate of increase of a cleaning blade #2;

FIG. 11 is a graph illustrating readings of Martens hardness of the intermediate transfer belt and If rate of increase of a cleaning blade #3;

FIG. 12 is a graph illustrating readings of Martens hardness of the intermediate transfer belt and If rate of increase of a cleaning blade #4;

FIG. 13 is a graph illustrating readings of Martens hardness of the intermediate transfer belt and If rate of increase of a cleaning blade #A;

FIG. 14 is a graph illustrating readings of Martens hardness of the intermediate transfer belt and If rate of increase of a cleaning blade #B;

FIG. 15 is a graph illustrating readings of Martens hardness of the intermediate transfer belt and If rate of increase of a cleaning blade #C;

FIG. 16 is a graph illustrating readings of Martens hardness of the intermediate transfer belt and If rate of increase of a cleaning blade #D;

FIG. 17 is a graph illustrating readings of Martens hardness of the intermediate transfer belt and If rate of increase of a cleaning blade #E;

FIG. 18 is a graph illustrating readings of Martens hardness of the intermediate transfer belt and If rate of increase of a cleaning blade #F;

FIG. 19 is a graph illustrating readings of Martens hardness of the intermediate transfer belt and If rate of increase of a cleaning blade #G; and

FIG. 20 illustrates a schematic configuration of a cleaning blade including a backup layer and a contact layer.

### DETAILED DESCRIPTION

Hereinafter, an exemplary embodiment of a color printer employing electrophotography (hereinafter “printer”) will be described.

First, a basic configuration of the printer will be described.

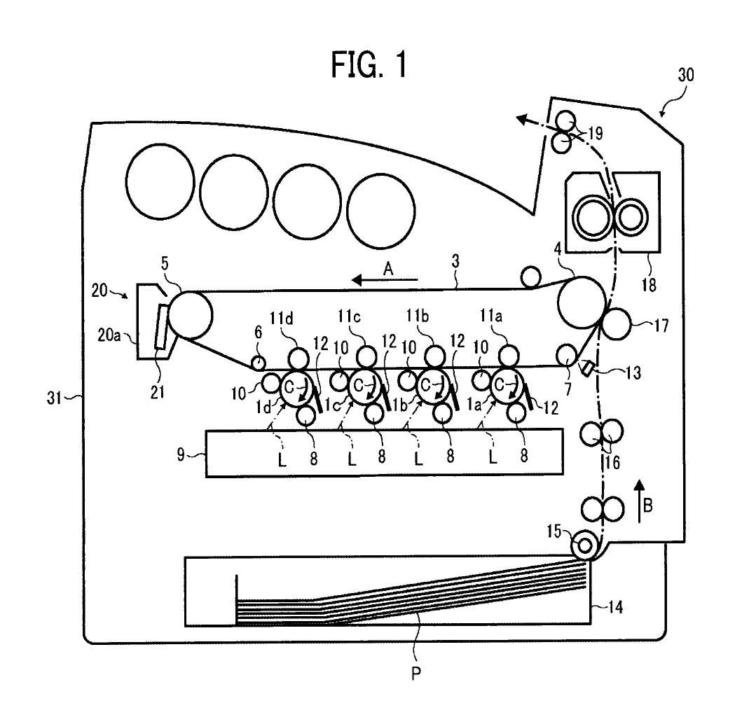

FIG. 1 is a schematic configuration of a printer 30 according to an embodiment of the present invention. The printer 30 is a tandem-type color printer and includes photoreceptors 1a, 1b, 1c, and 1d, as first to fourth image carriers, disposed inside an apparatus body 31.

Each photoreceptor 1a, 1b, 1c, and 1d is configured to form a toner image with different colors. Specifically, each photoreceptor 1a, 1b, 1c, and 1d forms a black toner image, a cyan toner image, a magenta toner image, and a yellow toner image, respectively. Further, as illustrated in FIG. 1, although the photoreceptors 1a, 1b, 1c, and 1d are drum-shaped, alternatively an endless belt-shaped photoreceptor may be used so that the belt is wound around a plurality of rollers and rotatably driven.

The intermediate transfer belt 3 made of resins is opposed to the photoreceptors 1a, 1b, 1c, and 1d, and each of the photoreceptors 1a, 1b, 1c, and 1d contacts a surface of the intermediate transfer belt 3. The intermediate transfer belt 3 is looped around a support roller 4, a tension roller 5, a backup roller 6, and an entrance roller 7. One of the rollers, for example, the support roller 4, is configured as a drive roller to be driven by a drive source, which causes the intermediate transfer belt 3 to be driven rotatably in the direction indicated by arrow A in the drawing.

The intermediate transfer belt 3 may have a multi-layer structure or a single layer structure, but at least the surface thereof is made of resins having a Martens hardness of 200 [N/mm²] or less. Preferred materials of the intermediate transfer belt 3 include polyvinylidene fluoride (PVDF), polycarbonate (PC), polyimide (PI), polyamideimide (PAI), polyphenilen sulfide (PPS), polyetherimide (PEI), and polyether ether ketone (PEEK).

Toner image formation to the photoreceptors 1a, 1b, 1c, and 1d and transferring each toner image to the intermediate transfer belt 3 are performed substantially similarly to each photoreceptor 1a, 1b, 1c, and 1d, except that each color of the formed toner image is different. Accordingly, a black toner image formation on the photoreceptor 1a and a transfer of the black toner image to the intermediate transfer belt 3 will be described as a representative example.

The photoreceptor 1a is driven to rotate in the clockwise direction as shown by arrow C in FIG. 1, during which light is irradiated from a discharger to a surface of the photoreceptor 1a, so that surface potential of the photoreceptor 1a is initialized. The surface of the photoreceptor 1a is evenly charged by a charger 8 at a predetermined polarity, which, in the present example, is a negative polarity. A modulated laser beam L is emitted from an exposure device 9 and directed onto the charged surface of the photoreceptor 1a, so that an electrostatic latent image corresponding to image data is formed on the surface of the photoreceptor 1a. In the exemplary image forming apparatus of FIG. 1, the exposure device 9 including the laser beam writing device that emits laser beams is used; however, alternatively another type of exposure device that has an LED array and imaging device may be used.

The electrostatic latent image formed on the photoreceptor 1a is rendered visible as a black toner image by the developing device 10. On the other hand, inside the loop formed by endless the intermediate transfer belt 3, a transfer roller 11 is disposed at a position opposite the photoreceptor 1a with the intermediate transfer belt 3 sandwiched in between. The transfer roller 11 contacts the interior of the intermediate transfer belt 3, so that a transfer nip is formed appropriately with the photoreceptor 1a and the intermediate transfer belt 3.

A transfer voltage of a polarity opposite that of the charge of the toner image formed on the photoreceptor 1a is applied to the transfer roller 11. In the present embodiment, the transfer voltage of the positive polarity is applied. As a result, a transfer electric field is formed between the photoreceptor 1a and the intermediate transfer belt 3, and the black toner image on the photoreceptor 1a is electrostatically transferred onto the intermediate transfer belt 3 that rotates in synchronous with the photoreceptor 1a. Residual toner remaining on the surface of the photoreceptor 1a after the black toner image has been transferred to the intermediate transfer belt 3 is removed by a cleaning device 12 and the surface of the photoreceptor 1a is cleaned.

Similarly, a cyan toner image, a magenta toner image, and a yellow toner image are respectively formed on the other photoreceptors 1b, 1c, and 1d, and the toner images of respective colors are sequentially superimposed one after another on the intermediate transfer belt 3 on which the black toner image has been transferred.

The printer 30 includes two modes: A full color mode in which toner image of four colors are used and a monochrome mode using black toner alone. In the full color mode, the intermediate transfer belt 3 and the photoreceptors 1a, 1b, 1c, and 1d contact each other, so that four toner images are transferred onto the intermediate transfer belt 3. By contrast, in the monochrome mode, the photoreceptor 1a alone contacts the intermediate transfer belt 3, so that the black toner alone is transferred to the intermediate transfer belt 3. In this case, the intermediate transfer belt 3 and photoreceptors 1b, 1c, and 1d do not contact each other, and the primary transfer rollers 11b, 11c, and 11d are separated from the photoreceptor via a separation mechanism. In this case, the backup roller 6 is moved to separate the intermediate transfer belt 3 from the photoreceptors 1b, 1c, and 1d for cyan, magenta, and yellow, to change the profile of the intermediate transfer belt 3.

As illustrated in FIG. 1, the printer 30 includes a sheet feed unit 14 in the bottom of the apparatus body 31. The sheet feed unit 14 contains in general a plurality of recording sheets P. When a sheet feed roller 15 rotates, a recording sheet P is sent out in the direction indicated by arrow B in the drawing. The recording sheet P fed from the sheet feed unit 14 is conveyed by a registration roller pair 16, at a predetermined timing, to a portion between a portion of the intermediate transfer belt 3 wound around the support roller 4 and a secondary transfer roller 17 disposed opposite the support roller 4. At this time, a predetermined transfer voltage is applied to the secondary transfer roller 17, whereby the superimposed toner image on the intermediate transfer belt 3 is secondarily transferred onto the recording sheet P.

The recording sheet P on which the toner image has been secondarily transferred is further conveyed upward to the fixing device 18, by which the toner image is fixed onto the recording medium P with heat and pressure. The recording sheet P that has passed through the fixing device 18 is discharged outside the image forming apparatus by a sheet discharge roller pair 19 disposed at a sheet discharge section.

A little toner remains on the intermediate transfer belt 3 after transferring image, but this residual toner is removed by a belt cleaning device 20 from the intermediate transfer belt 3.

The belt cleaning device 20 includes a cleaning blade 21. The cleaning blade 21 is an elastic member made of one or two layers of a material such as urethane rubber. The surface of the intermediate transfer belt 3 is cleaned such that a leading edge of the cleaning blade 21 is contacted against the surface of the intermediate transfer belt 3. In addition, the cleaning blade 21 includes a portion impregnated of at least one of acrylic resins and methacrylic resins at a leading portion thereof from a surface thereof toward an inner side. Then, the Martens hardness of the impregnated portion is from 2 to 10 [N/mm²]. The residual toner on the intermediate transfer belt 3 removed by the cleaning blade 21 drops into a cleaning case 20a, and is conveyed to a waste toner tank via a discharge screw disposed inside the cleaning case 20a.

Next, toner to be used in the printer 30 according to the present embodiment will be described.

The toner used in the printer 30 is preferably polymerized toner produced by a suspension polymerization method, an emulsion polymerization method, and a dispersion polymerization method for the purpose of improving an image quality. In those methods, a higher circularity and a smaller particle size of the toner can be obtained. In particular, polymerized toner having a circularity of 0.97 or more and volume average particle diameter of 5.5 [μm] or less may be preferably used. When the toner having the average circularity of 0.97 or more and the volume average particle diameter of 5.5 is used, an image with a higher resolution can be formed.

Here, “circularity” means an average circularity measured by Flow System Particle Image Analyzer FPIA-2000 (trade name, produced by TOA ELECTRIC CO., LTD.). Specifically, in 100 to 150 ml water from which impure solid material has been previously removed, surfactant as a disperser is added. Specifically, 0.1 to 0.5 ml of alkyl benzene sodium sulfonate and from 0.1 to 0.5 grams of a sample (toner) are added. Thereafter, the suspension liquid in which toner is dispersed is dispersed by an ultrasonic disperser for one to three minutes, so that a solution in which the density of the dispersion liquid becomes 3,000 to 1 [10,000/μl] is set to the above analyzer and a shape and distribution of the toner are measured. Based on the measurement result, C2/C1 is obtained, and the average amount is defined as the circularity, in which C1 is an outer peripheral length of an actual toner Projection shape, the projection area is S, and C2 is an outer peripheral length of a true circle having a same area as that of the projected area S.

In addition, the toner preferably used for the color printer can be obtained by the following method. Specifically, polyester, colorant, and a releasing agent are dispersed in an organic solvent to obtain a toner liquid, and a polyester prepolymer containing a functional group including at least a nitrogen atom and the toner liquid are subject to either a cross-linking or elongation reaction in an aqueous solvent.

Further, in the printer 30 according to the present embodiment, a process control is performed to optimize image density of each color at a time of power-on or when a predetermined number of prints are performed. In the process control, first, gray scale patterns of each color including a plurality of toner patches with different adhesion amounts (i.e., different densities) are formed on the intermediate transfer belt 3. In forming the gray scale patterns, by sequentially changing a charging bias and a developing bias at a proper timing, gray scale patterns formed of the plurality of toner patches with different adhesive amounts are formed. The gray scale patterns formed on the intermediate transfer belt 3 pass through a position opposite an optical sensor 13 when the intermediate transfer belt 3 endlessly moves. At this time, the optical sensor 13 receives a light amount corresponding to a toner adhesion amount per unit area of each toner patch of the gray scale pattern.

Next, the adhesion amount in each toner patch of the toner pattern of each color is obtained based on an output voltage of the optical sensor 13 when the toner patches of each color are detected and an adhesion amount conversion algorithm, and the image forming condition is adjusted based on the obtained adhesion amount. Specifically, based on a detection result of toner adhesion amount in the toner patch and a development potential when each toner patch is formed, a linear function (y=ax+b) representing a current developing capability is obtained by regression analysis. Then, by substituting a target value of the image density to the linear function, an appropriate development bias value can be obtained, and exposure power for Y, M, C, and K, charging bias, and developing bias may be specified.

In addition, if the developing device employs a two-component development method using two-component developer containing the toner and carriers, the image density can be controlled by changing the target control value of the toner density inside the developing device 10. Specifically, by changing the target value of the toner density control in the developing device 10 based on the detection result of the optical sensor 13, the maximum target adhesion amount, that is, the adhesion amount to obtain a target ID can be properly set.

In addition, the above optical sensor 13 is a reflective photosensor including a light emitting diode (LED) as a light emitting device and a photo diode (PD) or a photo transistor (PTr) as a light receiving device, in combination. In addition, the optical sensor 13 may employ a structure to detect specular reflected light alone from each toner patch of the gray scale pattern, a structure to detect diffused reflection light alone from the toner pattern for density detection, or a structure to detect both the specular reflected light and the diffused reflection light.

In any of the above structures, the reflected light amount needs to be detected accurately. If glossiness of the intermediate transfer belt is reduced due to film on and/or damage to the surface of the intermediate transfer belt, the detection result is degraded. In addition, because the detection performance is degraded when surface roughness of the intermediate transfer belt is large, the surface is preferably smooth.

As an intermediate transfer belt used in various printers, a resinous belt with a high elasticity (or Young's modulus) formed of polyimide (PI) may be used. On the other hand, because the image forming apparatus with a low cost is desired, an intermediate transfer belt 3 formed at a low cost is demanded. Preferred materials of such an intermediate transfer belt 3 include polyamideimide (PAI), polyvinylidene fluoride (PVDF), polycarbonate (PC), and polyphenilen sulfide (PPS) which are more cost effective than polyimide (PI).

PVDF and PC are inexpensive although their material costs are high because they can be produced continuously by extrusion molding effectively, and in addition, are thermoplastic resins capable of being produced by extrusion molding.

By contrast, a PI belt is expensive because, in addition to the high material cost, the PI belt is formed by centrifugal molding with batch process, of which production efficiency is low. Further, because the heat resistivity is high, temperature for drying is high, resulting in a longer production period.

The surface roughness of the belt produced by centrifugal molding depends on the roughness of the metal mold in the molding. Thus, by adjusting the surface roughness of the metal mold, the surface roughness of the surface of the belt can be adjusted so that a surface roughness in which photo detection can be optimally performed can be obtained. In addition, as to the glossiness, the PI belt and PAI belt formed by the centrifugal molding exert a sufficient glossiness for photo detection when new.

By contrast, a belt formed by the extrusion molding may have a surface roughness which fluctuates due to various reasons in the production process in addition to varied temperature over the belt. Compared to the belt formed by centrifugal molding, a belt formed by extrusion molding in general has a greater surface roughness. Thus, the belt formed by the extrusion molding may be treated with a surface polishing or a surface coating process to improve smoothness and glossiness of the surface. Such surface treatment, however, may increase the production cost.

As to the above-described reflection-type optical sensor 13, current to the LED is adjusted such that the mirror reflection output or Vsg from a background portion (that is, a portion with no toner adhered thereto) of the intermediate transfer belt 3 becomes a predetermined value (for example, 4.0+/−0.5V). This adjusting operation is defined as Vsg adjustment and the LED current determined by the Vsg adjustment is defined as “Vsg adjusted current” or “Ifsg.” The Vsg adjustment operation is performed before the process control operation. Thus, by performing the Vsg adjustment operation, a detection result with a higher precision can be obtained over time.

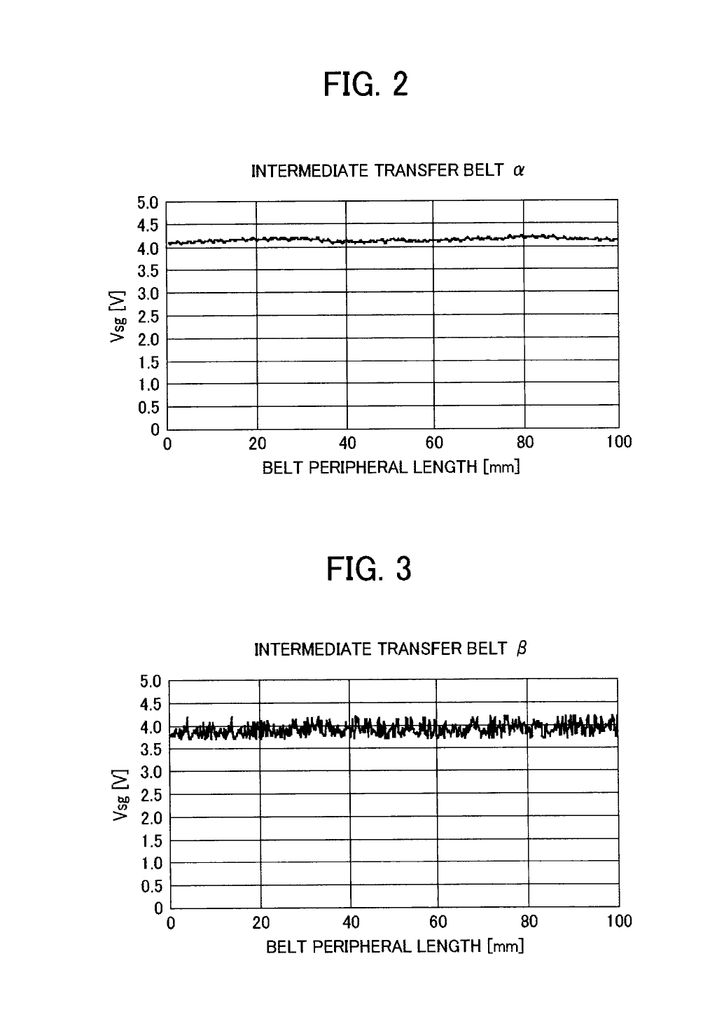

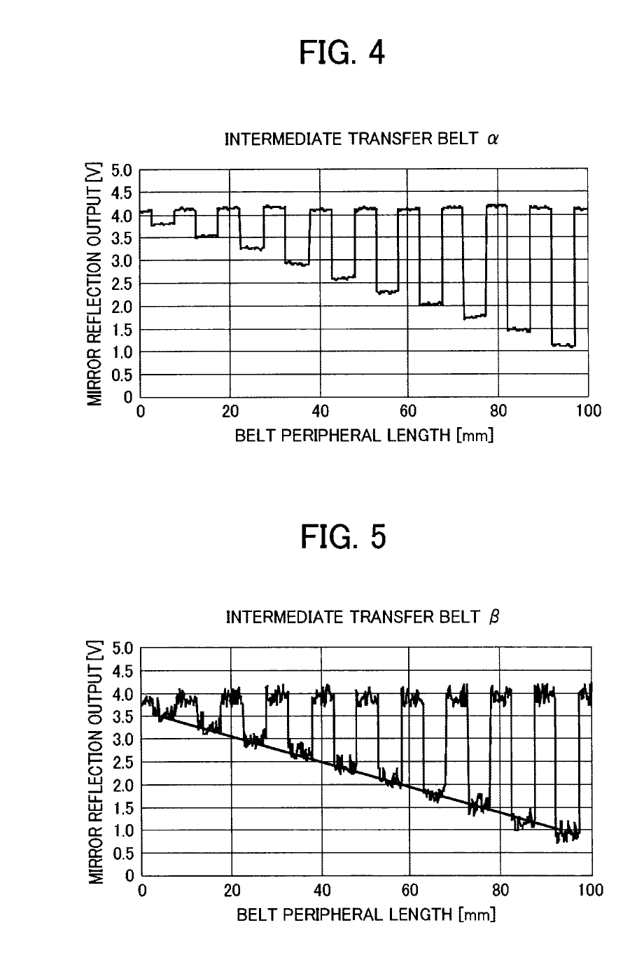

FIG. 2 is a graph illustrating Vsg fluctuations of an intermediate transfer belt α made of PI formed by centrifugal molding along a peripheral length of 100 mm. FIG. 3 is a graph illustrating Vsg fluctuations of an intermediate transfer belt β made of PPS formed by extrusion molding along a peripheral length of 100 mm. FIG. 4 is a graph illustrating initial mirror reflection output measured by an optical sensor of gray scale pattern formed of 10 toner patches of different densities formed on the intermediate transfer belt α. FIG. 5 is a graph illustrating initial mirror reflection output (of an initial stage of the belt) measured by an optical sensor of gray scale pattern formed of 10 toner patches of different densities formed on the intermediate transfer belt β.

Results of testing and measurements as illustrated in FIGS. 2 to 5 are obtained using an imagio MPC2201 apparatus (having the same basic structure of the image forming apparatus of FIG. 1, in which “imagio MPC2201” is a trade name, produced by Ricoh Company, Ltd.) and by modifying parts and components, and specifications of the related parts. As illustrated in FIGS. 2 and 3, Ifsg adjustment is performed so that Vsg becomes 4 volts. Ifsg of the intermediate transfer belt is 8.6 [mA], and Ifsg of the intermediate transfer belt β is 7.0 [mA].

The belt surface roughness Rz of the intermediate transfer belt α is 0.15 [μm] and Rz of the intermediate transfer belt β is 0.72 [μm]. Further, the glossiness of the belt surface of the intermediate transfer belt α (at an ambient temperature of 20° C.) is 135, and 117 for the intermediate transfer belt β. It is understood that stability of Vsg is improved as the belt surface roughness decreases and the glossiness of the belt surface increases. The surface roughness Rz is measured according to Rz defined by JIS-2001 standard.

As illustrated in FIGS. 3 and 5, detection precision of the intermediate transfer belt β with higher Vsg fluctuations is worse than the intermediate transfer belt α with lower Vsg fluctuations as illustrated in FIGS. 2 and 4. However, because a difference in peak voltages Max and Min of the intermediate transfer belt β is approximately 0.5 volts, the lowest possible detection precision can be secured if the difference is within this range. Thus, the intermediate transfer belt β formed by extrusion molding can secure the lowest possible detection precision in an initial stage.

Next, using these intermediate transfer belts α and β, and recording sheets “My Paper,” (trade name, produced by Ricoh), 10,000 sheets are printed as a test using the same document. As a result, the intermediate transfer belt α has no problem, but with the intermediate transfer belt β paper dust attached to a blank part where no image is printed, that is, paper dust filming occurred, resulting in reduced belt glossiness and increased Ifsg over time. If the surface of the intermediate transfer belt is damaged over time by foreign particles attached, the specular light amount is reduced. In such a case, the LED current amount is increased to retain an output as to the background portion. Specifically, there is a relation between the belt surface change and Ifsg. A rate of increase of the Ifsg compared to an initial state (i.e., a new belt) is called “If rate of increase.”

By quantifying a change in filming over time using the If rate of increase (equal to If current amount over time divided by an initial If ×100), a state of the filming is measured. When the If rate of increase rises, the specular light amount (for example, 4.0±0.5 volts) reduces. To compensate this, the LED current amount to the light emitting diode needs to be increased. However, if the amount of the current to be supplied to the light emitting diode is increased continuously to obtain a predetermined specular light amount, the light emitting diode is damaged. Therefore, an upper limit needs to be set for the If rate of increase. The light reflectivity varies depending on the material or the surface roughness of the belt, so that the upper limit of the If rate of increase varies from belt to belt. The If rate of increase of the intermediate transfer belt β produced by the extrusion molding exceeds the upper limit in an early stage compared to the intermediate transfer belt α. The intermediate transfer belt β produced by the extrusion molding cannot detect the light quantity properly due to the early occurrence of filming, resulting in a problem that image density control cannot be performed properly.

According to a further analysis on the paper dust adhered to the intermediate transfer belt β produced by the extrusion molding, it is understood that the adhered paper dust includes mainly calcium carbonate. The paper dust formed mainly of calcium carbonate includes hard, minute particles, which are not wiped off by an unwoven cloth with a slight force, but can be wiped off if scraped hard. It is understood that the paper dust is stuck up on the surface of the intermediate transfer belt β.

Herein, the intermediate transfer belt α made of PI produced by the centrifugal molding in which the paper dust film (or paper dust sticking) does not occur is harder than the intermediate transfer belt β made of PPS produced by the extrusion molding in which the paper dust film occurs. This leads to the conclusion that paper dust filming (occurrence of the paper dust) relates to the hardness of the belt, so that a relation between the Martens hardness of the belt and the paper dust filming has been investigated.

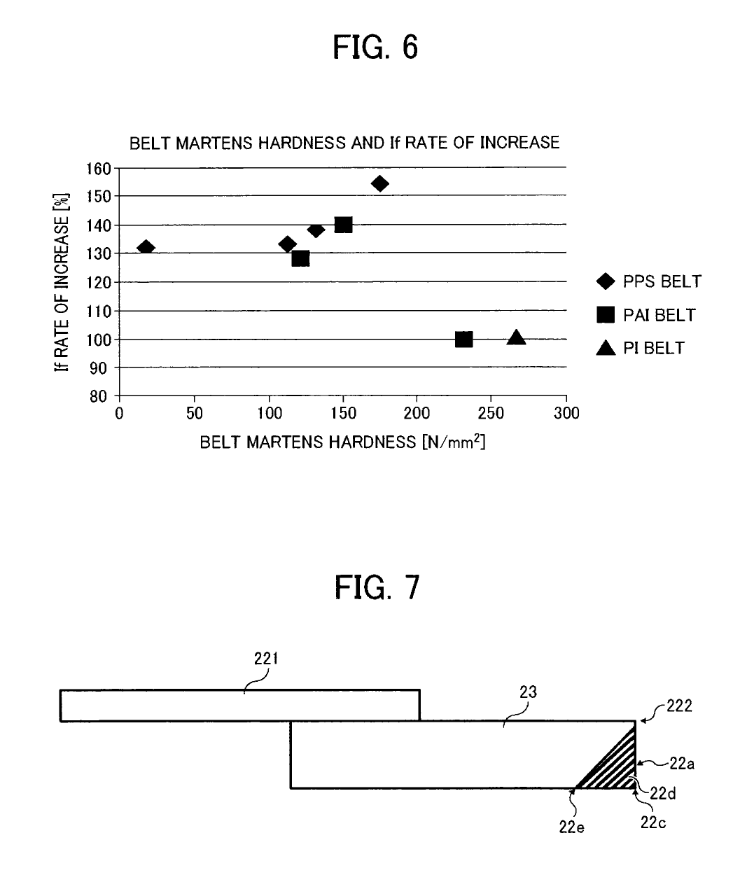

FIG. 6 is a graph illustrating readings of Martens hardness of the intermediate transfer belt 3 and If rate of increase.

In FIG. 6, intermediate transfer belts made of PPS each with a different Martens hardness, intermediate transfer belts made of PAI produced by centrifugal molding, and intermediate transfer belts made of PI produced by centrifugal molding were used. In addition, under the same conditions as above, Ifsg of blank portions of the belt after printing 10,000 sheets was measured, and a relation between Martens hardness and If rate of increase was investigated with the rate of increase from the initial Ifsg set as the If rate of increase.

The cleaning blade 21 to clean the intermediate transfer belt 3 used in the investigation is a two-layer blade and includes a contact layer to contact the belt and a backup layer connected and secured to a holder. The contact layer and the backup layer are made of urethane rubber. More specifically, the contact layer has a rubber hardness of 75 degrees (JIS-A scale) and the backup layer has rubber hardness of 70 degrees (JIS-A scale). The cleaning blade 21 has Martens hardness of 0.5 [N/mm²], a blade thickness of 2 [mm], and a blade contact linear pressure of 20 [gf/m].

As can be seen from FIG. 6, if the belt has a Martens hardness of 230 [N/mm²] or more, paper dust filming does not occur, Ifsg does not increase and stays at 100%. This is because the belt surface is sufficiently hard and the paper dust does not stick to the belt surface.

By contrast, if the belt has a Martens hardness of 180 [N/mm²] or less, If rate of increase becomes high as the Martens hardness is higher. Although the paper dust sticks to the belt when Martens hardness is 180 or less, if Martens hardness is low, it is conceivable that the belt surface is scraped by the cleaning blade 21 and the paper dust film is removed. As a result, it can be understood that as to the belt produced by extrusion molding, if Martens hardness is lowered, If rate of increase can be restricted. However, because the cleaning blade 21 scrapes the belt surface, there is a drawback in that the life of the intermediate transfer belt 3 will be shortened. Thus, a Martens hardness of the intermediate transfer belt 3 is preferably 180 [N/mm²] or greater.

In the image portion to which toner is constantly supplied, If rate of increase of any of the belts stays at 100%, and paper dust filming does not occur in the image portion. It is conceived therefore that an effective removal method of the paper dust is to perform blade cleaning after having adhered toner to the belt. However, supplying toner that is not contribute to image formation frequently is necessary, resulting in a useless toner consumption, and therefore is not preferable in view of saving resources.

As a result, various blades having a higher hardness in the surface contacting the belt are investigated to remove the paper dust. It is recognized that the paper filming can be removed effectively by using a blade with Martens hardness of from 2 to 10 [N/mm²].

Herein, the cleaning blade 21 to clean the surface of the intermediate transfer belt 3 according to an embodiment will be described.

FIG. 7 illustrates a schematic configuration of a cleaning blade 21 according to an embodiment of the present invention.

The cleaning blade 21 includes a rectangle holder 221 made of a rigid material such as metal or hardened plastic and a rectangle blade member 222. The blade member 222 is fixed to one end of the holder 221 and the other end of the holder 221 is supported by a case of the belt cleaning device 20.

The blade member 222 includes a base 23 made of polyurethane rubber with a rubber hardness of 72 degrees (JIS-A) that includes a leading edge 22c. The leading edge 22c includes an impregnated layer 22d impregnated with at least one of acrylic resins or methacrylic resins or a compound of an acrylic resins and methacrylic resins. The base of the blade member is a single layer of polyurethane rubber in the present embodiment, but alternatively may be two or more layers

Preferred materials for the base 23 are those having high impact resilience so as to be able to conform readily to slight swells on the surface of the intermediate transfer belt, and may include polyurethane rubber, and the like. On the other hand, if impact resilience is low, stick slip can be prevented, abrasion due to the blade can be prevented, and a longer life can be expected.

Accordingly, the impact resilience of the base 23 is preferably set to low within such a range that allows conformity with slight swells on the surface of the intermediate transfer belt. Specifically, the impact resilience compatible with the JIS K6255 Standard for the base is preferably 35% or less at 23° C. In addition, JIS-A hardness of the base is preferably 60 degrees or greater. If the hardness is below 60 degrees, a preferred blade linear pressure cannot be obtained, and a contact area with the intermediate transfer belt tends to expand, resulting in occurrence of defective cleaning.

The impregnated layer 22d disposed from the leading edge 22c of the base 23 to an inner predetermined dimension, is impregnated with acrylic resins, methacrylic resins, or a compound of acrylic resins and methacrylic resins. In particular, (meth)acrylate compound having an alicyclic structure with a carbon number of 6 or more in a molecule is preferable. (More preferable is (meth)acrylate compound having a tricyclodecane structure or (meth)acrylate compound having an adamantane structure. With immersion of such resins, the impregnated layer 22d becomes a compound of polyurethane rubber and acrylic resins, a compound of polyurethane rubber and methacrylic resins, or a compound of urethane rubber, acrylic resins and methacrylate resins. In the present example, the impregnated layer 22d includes a film thickness from the leading edge of 1.0 μm.

The leading edge 22c to contact the intermediate transfer belt 3 is thus subjected to the impregnation process, so that a Martens hardness of the leading edge 22c can be higher than that of the cleaning blade 21 without the impregnated layer 22d. Martens hardness can be measured with Microhardness measuring instrument H-100 (trade name, produced by Fischer Instruments), for example. In the present embodiment, the Martens hardness of the impregnated layer 22d is set to from 2 to 10 [N/mm²]. With such a structure, as described later, the paper dust film on the surface of the intermediate transfer belt 3 can be optimally removed. The Martens hardness of the leading edge 22c of the blade member 222 before impregnation is 0.5 [N/mm²].

By providing the impregnated layer 22d to the leading edge 22c, following effects are exerted:

1) Toner removal performance is drastically improved;
2) Abrasion of the blade member 222 is reduced, and cleaning performance is maintained over a long time; and
3) Friction coefficient between the blade member 222 and the intermediate transfer belt can be reduced.

The Martens hardness of the leading edge 22c of the blade member 222 can be set within a range from 2 to 10 [N/mm²] by covering the leading edge 22c with a rigid surface layer.

By contrast, the cleaning blade 21 according to the present embodiment is configured such that the leading edge 22c of the blade member 222 includes cross-linking resins such as acrylic resins or methacrylic resins to increase hardness. With such a structure, mechanical strength decrease of the rubber of the base due to swelling is prevented and network structure strength due to the impregnation of high hardness resinous material is achieved. As a result, without restricting the elastic deformation, durability over time can be secured. Specifically, to achieve collaterally prevention of the mechanical strength decrease of the rubber of the base and maintenance of the network structure strength of the high hardness resinous material, contents of the cross-linking resins included in the blade member 222 need to be properly controlled.

In addition, if the surface layer has a high hardness, the hardness drastically changes at a boundary between the surface layer with a high hardness and the base 23 with a low hardness. As a result, reaction power is concentrated at the boundary between the surface layer with a high hardness and the base 23 with a low hardness, thereby damaging the blade member 222. Accordingly, the blade member with a high hardness surface layer needs to be selected carefully. To cope with this problem, as implemented in the present embodiment, the leading edge of the blade member 222 is made to have a high hardness by impregnating process, so that the content of resins of the blade member 222 relative to the base 23 is gradually becoming less from the leading edge to a portion away from the leading edge. Thus, the sudden change in the hardness at the boundary between the high hardness layer and the base layer can be restricted, thereby preventing the blade member 222 from being damaged due to a concentrated stress.

JP-2004-233818-A discloses a structure in which the base of the blade member is impregnated with silicon-containing cross-linked resins with a lopsidedness and the surface of the blade member is covered by the same resins. The same document describes that the silicon-containing cross-linking resins of the cleaning blade is not excellent in the durability. The same also discloses an impregnation process in which the impregnation is performed over 12 hours, so that the impregnated amount of the cross-linked resins becomes excessive and the base rubber swells too much, and thus, the network structure of the rubber is destroyed, the mechanical strength decreases, and the durability deteriorates.

By contrast, the impregnated layer 22d of the present embodiment is soaked in a solution containing resinous impregnation materials over a predetermined time period with the leading edge 22c of the base 23 centered. With such a process, the impregnated layer 22d having a film thickness of 1.0 [μm] or more is formed from the leading edge 22c of the base 23. The solution containing the resinous impregnation materials includes, for example, acrylate monomers and polymerization initiator mixed with a solvent. The film thickness of the impregnated layer 22d from the leading edge 22c is determined by controlling the depth and time of the impregnation. A Martens hardness of the impregnated layer 22d can be set to 2 to 10 [N/mm²] by controlling the impregnation time. By applying heat and optical energy to the base after impregnating the base with the resinous materials, the resinous materials are cured. When, for example, ultraviolet curable resins are used as the resinous material for impregnation, first, the leading edge 22c of the base is impregnated with the ultraviolet curable resin, and ultraviolet rays are applied thereto to cure the resin, so that the impregnated layer 22d is formed. By forming the impregnated layer 22d as such, the hardness of the leading edge 22c increases and the durability is improved, and deformation of the base toward a moving direction is prevented. Further, when a surface layer to cover the leading edge 22c of the base 23 is disposed, even though the surface layer is abraded and an interior portion is exposed, the impregnated layer 22d restricts a deformation.

Next, a structure of the cleaning blade 21 will be described.

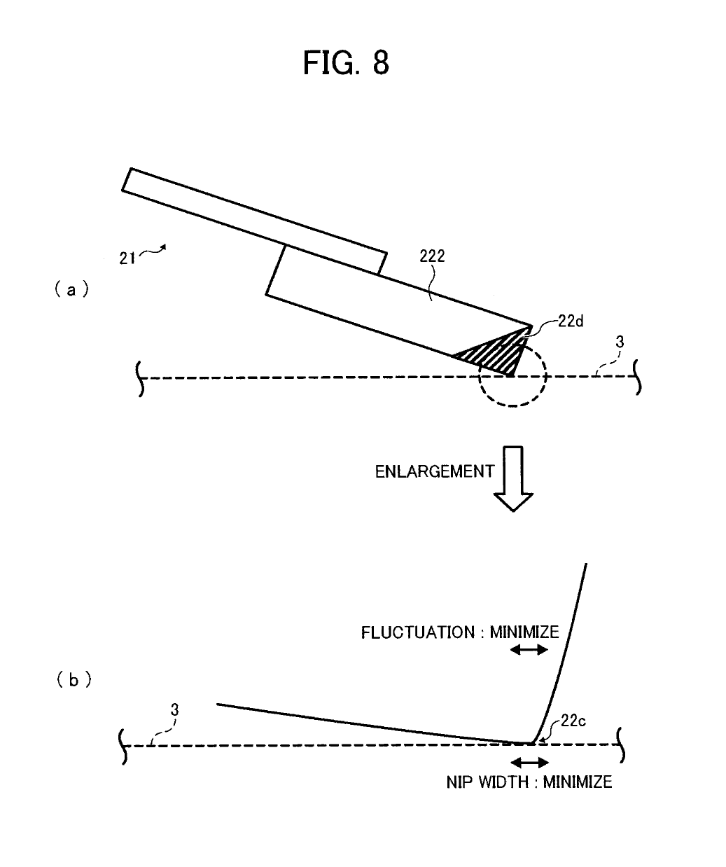

FIG. 8 illustrates a state of contact between the cleaning blade 21 and the intermediate transfer belt 3, and FIG. 8(b) is an enlarged figure of FIG. 8(a).

In the present embodiment, the leading edge 22c that contacts the intermediate transfer belt 3, of the blade member 222 is subjected to an impregnating process and the impregnated layer 22d is formed. Thus, the leading edge 22c is subjected to the impregnating process and therefore can be made rigid. As illustrated in FIG. 8(b), the leading edge 22c of the blade member can be prevented from deformation, deformation or fluctuation of the leading end of the blade member 222 can be reduced, so that the nip structure is stabilized optimally. Thus, a very optimal cleanability is obtained, and abrasion of the intermediate transfer belt 3 and of the blade is minimized. Further, curling of the leading edge 22c of the blade member 222 can be prevented. Abnormal noise such as chatter, and localized abrasion generated at a position away from the leading edge 22c of the leading end surface 22a of the blade by several micrometers, can also be prevented.

Because the leading edge 22c is rigid, when the cleaning blade 21 contacts the intermediate transfer belt 3, the blade member 222 can be bent reasonably. Thus, when the holder 221 is mounted with a slight inclination, a slanted contact between the belt and the blade member 222 due to a difference in the contact pressure at lateral ends in the belt width direction can be prevented.

Next, an example of the cleaning blade 21 will be described in greater detail.

<Base>

As to the base 23, shape, material, size, and structure thereof are in particular not limited, and can be appropriately selected according to purpose. The base may have a planar shape, reed shape, or a sheet shape, for example. The size of the base is not in particular limited, but may be selected properly in accordance with the size of the intermediate transfer belt.

The material of the base is not in particular limited, but may be appropriately selected in accordance with the purpose. Polyurethane rubber, polyurethane elastomer, and the like are preferably used because of their higher elasticity.

The structure of the base 23 is not in particular limited, but may be appropriately selected in accordance with the purpose. For example, using a polyol compound and a polyisocyanate compound, a polyurethane prepolymer is prepared. Next, a curing agent, and a curing catalyzer, if necessary, are added to the prepared polyurethane prepolymer so as to be cross-linked in a predetermined mold. The resultant compound, which is further subjected to posterior cross-linking in a furnace, is molded by the centrifugal molding into a sheet shape. Then, the resultant base material, which has been left at ambient temperature and aged, is cut into flat plates of a predetermined size.

The material for the polyol compound is not in particular limited, but may be appropriately selected in accordance with the purpose. For example, a high molecular weight polyol or a low molecular weight polyol may be used.

As the high molecular weight polyols, exemplary materials include, for example, polyester polyols as being condensation compounds of alkylene glycol and aliphatic dibasic acid; polyester polyols as condensation compounds of alkylene glycol and adipic acid such as ethyleneadipate ester polyol, butylene adipate ester polyol, hexylen adipate ester polyol, ethylene propylene adipate ester polyol, ethylene butylene adipate ester polyol, ethylene neopentylene adipate ester polyol; polycaprolactone polyols such as polycaprolactone esterpolyol obtained by subjecting caprolactone to ring-opening polymerization; polyether polyols such as poly(oxytetramethylene)glycol, poly(oxypropylene)glycol, and the like. These compounds may be used individually or in combination with two or more compounds.

Examples of the low molecule weight polyols include, for example, dihydric alcohols such as 1,4-butanediol, ethylene glycol, neopentyl glycol, hydroquinone-bis(2-hydroxyethyl)ether, 3,3′-dichloro-4,4′-diaminodiphenylmethane, 4,4′-diaminodiphenylmethane; trihydric or polyhydric alcohols including more than three hydroxyl functions such as 1,1,1-trimethylolpropane, glycerine, 1,2,6-hexantriol, 1,2,4-butanetriol, trimethylolethane, 1,1,1-tris(hydroxyethoxymethyl)propane, diglycerine, pentaerythritol. These compounds may be used individually or in combination.

The material for the polyisocyanate compounds is not in particular limited, but may be appropriately selected in accordance with the purpose. For example, methylenediphenyldiisocyanate (MDI), tolylenediisocyanate (TDI), xylylenediisocyanate (XDI), naphthylene-1,5-diisocyanate (NDI), tetramethylxylenediisocyanate (TMXDI), isophoronediisocyanate (IPDI), hydrogenated xylenediisocyanate (H₆XDI), dichlorohexylmethanediisocyanate (H₁₂MDI), hexamethylene diisocyanate (HDI), dimer acid diisocyanate (DDI), norbornene diisocyanate (NBDI), and trimethylhexamethylene diisocyanate (TMDI) are included as preferred materials. These compounds may be used individually or in combination.

The material for the curing catalyzer is not in particular limited, but may be appropriately selected in accordance with the purpose. For example, preferred materials include: 2-methylimidazole, and 1,2-dimethylimidazole.

The content of the curing catalyzer is not in particular limited, but may be appropriately selected in accordance with the purpose; however, 0.01 to 0.5 mass % is preferable, and 0.05 to 0.3 mass % is more preferable.

The JIS-A hardness of the base 23 is not in particular limited, but may be appropriately selected in accordance with the purpose; however, 60 degrees or more is preferable, and 65 to 80 degrees is more preferable. If the above JIS-A hardness is below 60 degrees, the blade linear pressure is difficult to obtain and a contact area with the intermediate transfer belt tends to expand, leading to defective cleaning.

The material for the base 23 is not in particular limited, but may be appropriately selected in accordance with the purpose; however, use of a laminated product in which two or more types of rubber with different JIS-A hardness are integrally formed may be preferable because both abrasion resistance and tracking will be achieved collaterally.

The JIS-A hardness can be measured by Micro rubber hardness meter MD-1 (trade name, produced by KOBUNSHI KEIKI CO., LTD.), for example.

The impact resilience of the base 23 compatible with the JIS K625 standard is not in particular limited, but may be appropriately selected in accordance with the purpose; however, 35% or less at ambient temperature of 23° C. is preferable, and 20 to 30% is more preferable. If the above impact resilience exceeds 35%, the base of the cleaning blade shows tack property, thereby causing a stick slip to occur, abnormal chattering sound and abnormal abrasion.

Herein, the impact resilience of the base 23 is measured in an ambient temperature of 23° C. by No. 221 Resilience tester (trade name, produced by TOYO SEIKI SEISAKU-SHO, LTD.) compatible with JIS K6255 Standard.

An average thickness of the base 23 is not in particular limited, but may be appropriately selected in accordance with the purpose; however, 1.0 to 3.0 mm would be preferable.

<Impregnated Layer>

Preferred resinous materials used to impregnate the leading edge 22c of the base 23 include: ultraviolet curable composition including acrylic resins and/or methacrylic resins. Specifically, as long as at least the leading edge 22c of the base 23 includes ultraviolet curable composition including the acrylic resins and/or methacrylic resins, portions other than the leading edge 22c of the base 23 may include ultraviolet curable composition including the acrylic resins and/or methacrylic resins.

<Ultraviolet Curable Composition>

Preferred materials for the acrylic resins and/or methacrylic resins included in the ultraviolet curable composition include (meth)acrylate compounds including alicyclic structure with six or more number of carbon atoms in the molecule, and other component can be added thereto, if needed. (Meth)acrylate compound including alicyclic structure with six or more number of carbon atoms in the molecule includes a leveled, specific alicyclic structure in the molecule, so that the (meth)acrylate compound with a low number of functional groups and a small total molecular weight can be used. As a result, the leading edge 22c of the base 23 is impregnated with the above compound, thereby effectively improving the hardness of the leading edge 22c. In addition, if the leading edge 22c is provided with a surface layer, cracks or flakes on the surface layer can be prevented.

The number of carbon atoms included in the molecule of the (meth)acrylate compound having alicyclic structure with six or more carbon atoms in the molecule is preferably from 6 to 12, and more preferably from 8 to 10. If the number of carbon atoms is less than six, the hardness of the leading edge 22c or the impregnated layer 22d may be lowered; and if more than 12, steric hindrance may occur.

The number of functional groups of the (meth)acrylate compound having alicyclic structure with six or more carbon atoms in the molecule is preferably from 2 to 6, and more preferably from 2 to 4. If the number of functional groups is less than two, the hardness of the leading edge 22c or the impregnated layer 22d may be lowered; and if more than 6, steric hindrance may occur.

The molecular weight of the (meth)acrylate compound having alicyclic structure with six or more carbon atoms in the molecule is preferably less than 500. If the molecular weight exceeds 500, impregnation of the base 23 would be difficult because of the large molecular size, so that the high hardness of the base 23 may not be implemented.

Preferred materials for the (meth)acrylate compound having an alicyclic structure with 6 or more carbon atoms in the molecule include at least one of (meth)acrylate compound having a tricyclodecane structure and (meth)acrylate compound having an adamantane structure. These acrylate compounds may compensate for insufficient cross-linking points by the specific alicyclic structure even with fewer functional groups.

The material for the (meth)acrylate compound with the tricyclodecane structure is not in particular limited, but may be appropriately selected in accordance with the purpose. For example, tricyclodecane dimethanol diacrylate, and tricyclodecane dimethanol dimethacrylate may be used.

Preferred materials for the (meth)acrylate compound with the tricyclodecan structure include compounds properly synthesized or a commercial product in the market, which includes, for example, A-DCP (trade name, produced by Shin-Nakamura Chemical Co., Ltd.).

The material for the (meth)acrylate compound with the adamantane structure is not in particular limited, but may be appropriately selected in accordance with the purpose. For example, 1,3-adamantane dimethanol diacrylate, 1,3-adamantane dimethanol dimethacrylate, 1,3,5-adamantane trimethanol triacrylate, 1,3,5-adamantane trimethanol trimethacrylate may be used.

Preferred materials for the (meth)acrylate compound with the adamantane structure include compounds properly synthesized or a commercial product in the market. The commercial product includes X-DA and X-A-201 (trade names, both produced by Idemitsu Kosan Co., Ltd.) and ADTM (trade name, produced by Mitsubishi Gas Chemical Company, Inc.).

The content of the (meth)acrylate compound with the alicyclic structure with 6 or more carbon atoms in the molecule is not in particular limited, but may be appropriately selected in accordance with the purpose. However, the content of the (meth)acrylate compound relative to the ultraviolet curable composition is preferably from 20 to 100 mass % and is more preferably from 50 to 100 mass %. If the content is less than 20 mass %, the high hardness due to the specific alicyclic structure is degraded.

That the leading edge 22c contacting the surface of the intermediate transfer belt, of the base 23 includes the (meth)acrylate compound having the alicyclic structure with 6 or more carbon atoms in the molecule (in particular, the (meth)acrylate compound with the tricyclodecane structure or the (meth)acrylate compound with the adamantane structure) can be analyzed by an ultrared microscopy or a liquid chromatography.

The above ultraviolet curable composition may contain (meth)acrylate compounds with the molecular weight of from 100 to 1,500 other than the (meth)acrylate compounds with the alicyclic structure with 6 or more carbon atoms in the molecule.

The (meth)acrylate compounds having the molecular weight of from 100 to 1,500 is not in particular limited, but may be appropriately selected in accordance with the purpose. Preferred materials include, for example: Di-pentaerythritol hexa(meth)acrylate, pentaerythritol tetra(meth)acrylate, pentaerythritol tri(meth)acrylate, pentaerythritolethoxy tetra(meth)acrylate, trimethylpropane tri(meth)acrylate, trimethylolpropaneethoxy(meth)acrylate, 1,6-hexanediol di(meth)acrylate, ethoxylated bisphenol A di(meth)acrylate, propoxylated ethoxylated bisphenol A di(meth)acrylate, 1,4-butanediol di(meth)acrylate, 1,5-pentanediol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, 1,11-undecanediol di(meth)acrylate, 1,18-octadecanediol di(meth)acrylate, glycerinpropoxy tri(meth)acrylate, dipropyleneglycol di(meth)acrylate, tripropyleneglycol di(meth)acrylate, PO-denatured neopentylglycol di(meth)acrylate, PEG #600 di(meth)acrylate, PEG #400 di(meth)acrylate, PEG #200 di(meth)acrylate, neopentyl glycol hydroxy pivalic acid ester di(meth)acrylate, octyl/decyl(meth)acrylate, osobornyl(meth)acrylate, ethoxylated phenyl (meth)acrylate, 9,9-bis[4-(2-(meth)acryloyloxyethoxy)phenyl]fluorene, and the like. These compounds may be used individually or in combination. Among the above materials, compounds having a pentaerythritol triacrylate structure with functional groups of 3 to 6 are preferable.

Examples of the compounds having a pentaerythritol triacrylate structure with functional groups of 3 to 6 include, for example, pentaerythritoltriacrylate, dipentaerythritolhexaacrylate, and the like.

<Others>

Other materials to impregnate the leading edge 22c are not in particular limited, but may be appropriately selected in accordance with the purpose. For example, photopolymerization initiator, polymerization suppressor, dilution agent, and the like.

<Photopolymerization Initiator>

The material for the photopolymerization initiator is not in particular limited, but may be appropriately selected in accordance with the purpose as long as the material may grow active species and initiate polymerization by the energy of light. Preferred materials include photoradical polymerization initiator, photocation polymerization initiator, and the like. Among these, photoradical polymerization initiator is in particular preferable.

Preferred materials for the photoradical polymerization initiator include, for example, aromatic ketone compounds, acylphosphine oxide compounds, aromatic onium salt compounds, organic peroxides, thio compounds (including thioxanthone compounds, thiophenyl-group containing compounds, and the like), hexalylbiimidazol compounds, ketoxime ester compounds, borate compounds, azinium compounds, metallocene compounds, active ester compounds, compounds containing carbon-halogen bonds, alkylamine compounds, and the like.

The material of the photoradical polymerization initiator is not in particular limited, but may be appropriately selected in accordance with the purpose. Preferred materials include, for example: acetophenone, acetophenonebenzylketal, 1-hydroxycyclohexylphenylketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoisopropyl ether, benzoisoethyl ether, benzildimethylketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxantone, 2-chlorothioxanthone, 2-methyl-1-[4-(methylthio)phenyl]-2-morpholino-propane-1-one, bis(2,4,6-trimethylbenzoyl)-phenylphosphine oxide, 2,4,6-trimetylbenzoyl-diphenyl-phosphine oxide, 2,4-diethylthioxanthone, bis-(2,6-dimethoxybenzoyl)-2,4,4-trimethylpentylphosphine oxide, and the like. These compounds may be used individually or in combination.

The photoradical polymerization initiator may employ one of commercial products. Preferred commercial products include, for example: Irgacure #651, Irgacure 184, DAROCUR 1173, Irgacure 2959, Irgacure 127, Irgacure 907, Irgacure 369, Irgacure 379, DAROCURTPO, Irgacure 819, Irgacure 784, Irgacure OXE 01, Irgacure OXE 02, Irugacure 754 (trade names, produced by Chiba Specialty Chemicals); Speedcure TPO (produced by Lambson Ltd.); KAYACURE DETX-S (produced by Nippon Kayaku Co., Ltd.); Lucirin TPO, LR8893, LR8970 (trade names, produced by BASF SE); Ubecryl P36 (produced by Union Chimique Belge, UCB), and the like. These compounds may be used individually or in combination.

The content of the photopolymerization initiator is not in particular limited, but may be appropriately selected in accordance with the purpose; however, 1 to 20 mass % relative to the ultraviolet curable composition is preferable.

<Polymerization Suppressor>

The material of the polymerization suppressor is not in particular limited, but may be appropriately selected in accordance with the purpose. Preferred materials include, for example: phenol compounds such as p-methoxyphenol, cresol, t-butylcatechol, di-t-butylparacresol, hydrokinone monomethyl ether, α-naphthol, 3,5-di-t-butyl-4-hydroxytoluene, 2,2′-methylenebis(4-methyl-6-t-butylphenol), 2,2′-methylenebis(4-ethyl-6-t-butylphenol), and 4,4′-thiobis(3-methyl-6-t-butylphenol); quinone compounds such as p-benzoquinone, anthraquinone, naphthoquinone, phenanthraquinone, p-xyloquinone, p-toluquinone, 2,6-dichloroquinone, 2,5-diphenyl-p-benzoquinone, 2,5-diacetoxy-p-benzoquinone, 2,5-dicaproxy-p-benzoquinone, 2,5-diacyloxy-p-benzoquinone, hydroquinone, 2,5-di-butylhydroquinone, mono-t-butylhydroquinone, monomethylhydroquinone, and 2,5-di-t-amylhydroquinone; amine compounds such as phenyl-β-naphthylamine, p-benzylaminophenol, di-β-naphthylparaphenylenediamine, dibenzylhydroxylamine, phenylhydroxylamine, and diethylhydroxylamine; nitro compounds such as dinitrobenzene, trinitrotoluen, and picric acid; oxyme compounds such as quinonedioxyme and cyclohexaneoxyme; and sulfur compounds such as phenothiazine. These compounds may be used individually or in combination.

<Dilution Agent>

The material of the dilution agent is not in particular limited, but may be appropriately selected in accordance with the purpose. Preferred materials include, for example: hydrocarbon solvent such as toluene, and xylene; ester solvent such as methyl cellosolve acetate, and propyleneglycolmonoethyletheracetate; ketone solvent such as methylethylketone, methylisobutylketone, diisobutylketone, cyclohexanone, and cyclopenthanone; ether solvent such as ethyleneglycolmonomethylether, ethyleneglycolmonoethylether, propyleneglycolmonomethylether; alcohol solvent such as ethanol, propanol, 1-butanol, isopropylalcohol, and isobutylalcohol. These compounds may be used individually or in combination.

The method to impregnate the leading edge 22c of the base 23 with the curing material of the ultraviolet curable composition containing (meth)acrylate compounds having the alicyclic structure with 6 or more carbon atoms in the molecule is not in particular limited, but may be appropriately selected in accordance with the purpose. For example, there are three methods as follows:

(1) The ultraviolet curable composition is coated with a brush on the leading edge 22c of the base 23, and the subject portion is soaked by dip coating. Then, ultraviolet rays are applied and the subject portion is caused to be cured.

(2) The ultraviolet curable composition is coated with a brush on the leading edge 22c of the base 23, and the subject portion is soaked by dip coating. Then, ultraviolet curable composition is sprayed to the leading edge 22c to form a surface layer. Ultraviolet rays are applied and the subject portion is caused to be cured.

(3) The ultraviolet curable composition is coated with a brush on the leading edge 22c of the base 23, and the subject portion is soaked by dip coating. Then, ultraviolet rays are applied to cure the subject portion. Then, ultraviolet curable composition is sprayed to the leading edge 22c to form a surface layer.

Among those, the above method (1) is most preferable.

Irradiation condition of the ultraviolet rays is not in particular limited, but may be appropriately selected in accordance with the purpose; however, accumulated light quantity is preferably from 500 to 5,000 [mJ/cm²].

That the leading edge 22c of the base 23 is impregnated with the ultraviolet curable composition having the (meth)acrylate compound having the alicyclic structure with 6 or more carbon atoms in the molecule (in particular, the (meth)acrylate compound with the tricyclodecane structure or the (meth)acrylate compound with the adamantane structure preferred) allows the leading edge 22c of the base 23 to be cured highly, thereby preventing the leading edge 22c from bending and deforming. Further, even though the leading edge 22c is abraded and an interior portion is exposed, the impregnation effect to the interior may restrict bending and deformation.

Hereinafter, an example of preparing the ultraviolet curable composition to impregnate the leading edge 22c will be described.

### Preparation Example #1

### Preparation of a First Ultraviolet Curable Composition

From a composition below, the first ultraviolet curable composition is prepared by a common method.

Tricyclodecane dimethanol diacrylate presented by the following structural formula (produced by Shin-Nakamura Chemical Co., Ltd., Trade name: A-DCP, Number of functional groups: 2, Molecular weight: 304) . . . 50 parts by mass

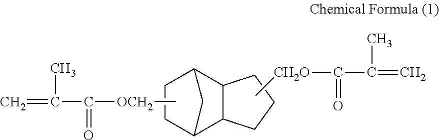

Photopolymerization initiator (Irgacure 184 produced by Chiba Specialty Chemicals) . . . 5 parts by mass

Solvent (cyclohexanone) . . . 55 parts by mass

### Preparation Example 2

### Preparation of a Second Ultraviolet Curable Composition

From a composition below, the second ultraviolet curable composition is prepared by a common method.

(Meth)acrylate compound #1 with adamantane structure represented by the following structural formula (produced by Idemitsu Kosan Co., Ltd., Trade name: X-DA, Number of functional groups: 2, Molecular weight: 276 to 304, reaction product of 1,3-adamantanediol and acrylate) . . . 50 parts by mass

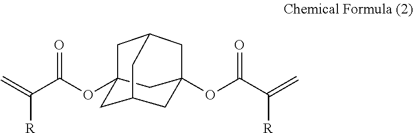

wherein, R represents hydrogen atom or methyl group.

Photopolymerization initiator (Irgacure 184 produced by Chiba Specialty Chemicals) . . . 5 parts by mass

Solvent (cyclohexanone) . . . 55 parts by mass

### Preparation Example 3

### Preparation of a Third Ultraviolet Curable Composition

From a composition below, the third ultraviolet curable composition is prepared by a common method.

(Meth)acrylate compound #2 with adamantane structure represented by the following structural formula (1,3-adamantanedimethanoldiacrylate, produced by Idemitsu Kosan Co., Ltd., Trade name: X-A-201, Number of functional groups: 2, Molecular weight: 304) . . . 50 parts by mass

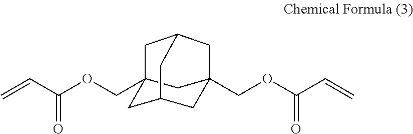 [SMILES: C=CC(=O)OCC12CC3CC(C1)CC(COC(=O)C=C)(C3)C2]

Photopolymerization initiator (Irgacure 184 produced by Chiba Specialty Chemicals) . . . 5 parts by mass Solvent (cyclohexanone) . . . 55 parts by mass

### Preparation Example 4

### Preparation of a Fourth Ultraviolet Curable Composition

From a composition below, the fourth ultraviolet curable composition is prepared by a common method.

(Meth)acrylate compound #3 with adamantane structure represented by the following structural formula (produced by Mitsubishi Gas Chemical Company, Inc., Trade name: Diapureste ADTM, Number of functional groups: 3, Molecular weight: 388) . . . 50 parts by mass

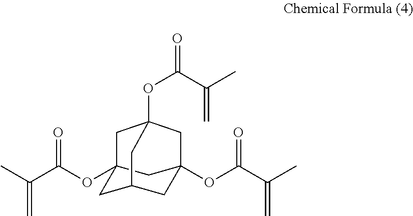 [SMILES: C=C(C)C(=O)OC12CC3CC(OC(=O)C(=C)C)(C1)CC(OC(=O)C(=C)C)(C3)C2]

Photopolymerization initiator (Irugacure 184 produced by Chiba Specialty Chemicals) . . . 5 parts by mass

Solvent (cyclohexanone) . . . 55 parts by mass

### Preparation Example 5

### Preparation of a Fifth Ultraviolet Curable Composition

From a composition below, the fifth ultraviolet curable composition is prepared by a common method.

Tricyclodecane dimethanol diacrylate represented by the foregoing structural formula (produced by Shin-Nakamura Chemical Co., Ltd., Trade name: A-DCP, Number of functional groups: 2, Molecular weight: 304) . . . 25 parts by mass

Pentaerythritol triacrylate represented by the following structural formula (produced by Daicel-Cytec Company Ltd., Trade name: PETIA, Number of functional groups: 3, Molecular weight: 298) . . . 25 parts by mass

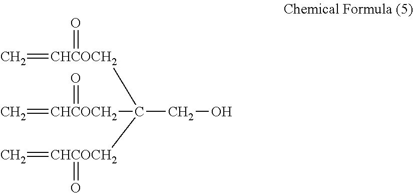

Photopolymerization initiator (Irgacure 184 produced by Chiba Specialty Chemicals) . . . 5 parts by mass

Solvent (cyclohexanone) . . . 55 parts by mass

### Preparation Example 6

### Preparation of a Sixth Ultraviolet Curable Composition

From a composition below, the sixth ultraviolet curable composition is prepared by a common method.

(Meth)acrylate compound #2 with adamantane structure represented by the foregoing structural formula (1,3-adamantanedimethnoldiacrylate, produced by Idemitsu Kosan Co., Ltd., Trade name: X-A-201, Number of functional groups: 2, Molecular weight: 304) . . . 25 parts by mass

Pentaerythritol triacrylate represented by the foregoing structural formula (produced by Daicel-Cytec Company Ltd., Trade name: PETIA, Number of functional groups: 3, Molecular weight: 298) . . . 25 parts by mass Photopolymerization initiator (Irgacure 184 produced by Chiba Specialty Chemicals) . . . 55 parts by mass

Solvent (cyclohexanone) . . . 55 parts by mass

### Preparation Example 7

### Preparation of a Seventh Ultraviolet Curable Composition

From a composition below, the seventh ultraviolet curable composition is prepared by a common method.

Pentaerythritol triacrylate represented by the foregoing structural formula (Trade name: PETIA, Produced by Daicel-Cytec Company Ltd., Number of functional groups: 3, Molecular weight: 298) . . . 50 parts by mass

Photopolymerization initiator (Irgacure 184 produced by Chiba Specialty Chemicals) . . . 55 parts by mass

Solvent (cyclohexanone) . . . 55 parts by mass

### Preparation Example 8

### Preparation of an Eighth Ultraviolet Curable Composition

From a composition below, the eighth ultraviolet curable composition is prepared by a common method.

Dientaerythritol hexaacrylate represented by the following chemical formula (Produced by Daicel-Cytec Company Ltd., Trade name: DPHA, Number of functional groups: 6, Molecular weight: 578) . . . 59 parts by mass

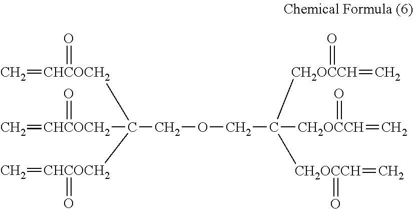

Photopolymerization initiator (Irgacure 184 produced by Chiba Specialty Chemicals) . . . 5 parts by mass

Solvent (cyclohexanone) . . . 55 parts by mass

The above preparation examples are simply examples, and may be properly changed in accordance with the purpose.

The material of the base 23 of the cleaning blade is not in particular limited, but may be appropriately selected in accordance with the purpose; however, it is preferred that the base 23 contacts the surface of the intermediate transfer belt at a press strength of from 10 to 100 [N/m]. If the above press strength is below 10 [N/m], toner passes through and is not cleaned well at a portion where the base of the cleaning blade contacts the surface of the image carrier. Further, if the press strength exceeds 100 [N/m], the cleaning blade rides up due to an increase of frictional force at the contact portion. Accordingly, the press strength is preferably from 10 to 50 [N/m].

The press strength can be measured by measuring equipment produced by Kyowa Electronic Instruments Co., Ltd., in which a compact compression load cell is incorporated.

An angle formed by a tangent line at the contact portion where the base 23 of the cleaning blade contacts the surface of the intermediate transfer belt and an edge face of the cleaning blade is not in particular limited, but may be appropriately selected in accordance with the purpose; however, the angle is preferably 65 degrees or more and 85 degrees or less.

If the above angle θ is below 65 degrees, the cleaning blades rides up. If the above angle θ exceeds 85 degrees, a defective cleaning may occur.

Next, a description will be given of verification experiments 1 and 2.

### Verification Experiment 1

The verification experiment 1 is performed using seven intermediate transfer belts each having Martens hardness different from each other and four cleaning blades of which the leading edges 22c each have Martens hardness different from each other. In the verification experiment 1, using recording sheets “My Paper,” (trade name, produced by Ricoh), 10,000 sheets are printed as a test using the same document and the If rate of increase of the blank portions has been verified as an index of paper dust filming. The If rate of increase of the blank portions was measured using M-color toner, by continuously printing 10,000 sheets dividing into two sections, where the toner is input on the belt and where the toner is not input. The target If rate of increase is set to below 150%. The target If rate of increase for determination of good and no good was set to 150% due to the reason as described below: As the If rate of increase becomes high, the Vsg fluctuations as described above increases and detection accuracy of the optical sensor 13 worsens. The If rate of increase that does not cause any abnormal Vsg fluctuations (so that the detection accuracy of the optical sensor 13 can be kept) is below 150%.

Martens hardness of the intermediate transfer belt and that of the cleaning blade were measured using Microhardness measuring instrument H-100 produced by Fischer Instruments under the following conditions:

Martens hardness of the intermediate transfer belt
Maximum load: 2 [mN]

Time period up to the maximum load: 10 sec.
Creep time: 10 sec.
Loading period: 10 sec.

Martens hardness of the cleaning blade
Maximum load: 1 [mN]

Time period up to the maximum load: 10 sec.
Creep time: 5 sec.
Loading period: 10 sec.

Next, the intermediate transfer belt 3 used for the verification experiments will be described.

Intermediate Transfer Belt #1

Material: PPS (polyphenilen sulfide); Martens hardness: 17[N/mm²]; Thickness: 80 [μm]; Linear speed: 256 [mm/s]; and Tension: 1.3 [N/cm]

Intermediate Transfer Belt #2

Material: PPS (polyphenilen sulfide); Martens hardness: 113 [N/mm²]; Thickness: 80 [μm]; Linear speed: 256 [mm/s]; and Tension: 1.3 [N/cm]

Intermediate Transfer Belt #3

Material: PPS (polyphenilen sulfide); Martens hardness: 132 [N/mm²]; Thickness: 80 [μm]; Linear speed: 256 [mm/s]; and Tension: 1.3 [N/cm]

Intermediate Transfer Belt #4

Material: PPS (polyphenilen sulfide); Martens hardness: 175 [N/mm²]; Thickness: 80 [μm]; Linear speed: 256 [mm/s]; and Tension: 1.3 [N/cm]

Intermediate Transfer Belt #5

Material: PAI (polyamideimide); Martens hardness: 121 [N/mm²]; Thickness: 80 [μm]; Linear speed: 256 [mm/s]; and Tension: 1.3 [N/cm]

Intermediate Transfer Belt #6

Material: PAI (polyamideimide); Martens hardness: 150 [N/mm²]; Thickness: 80 [μm]; Linear speed: 256 [mm/s]; and Tension: 1.3 [N/cm]

Intermediate Transfer Belt #7

Material: PAI (polyamideimide); Martens hardness: 230 [N/mm²]; Thickness: 80 [μm]; Linear speed: 256 [mm/s]; and Tension: 1.3 [N/cm]

Next, the cleaning blade 21 used for the verification experiments will be described.

The base 23 of the cleaning blade 21 was made using the production method of the cleaning blade as described in the first embodiment of JP-2011-141449-A.

The thus-formed base was secured to a metal mold holder being a support member with an adhesive, so as to obtain a cleaning blade #1.

Cleaning blades #2 to #4 were produced by the following method. The above described first ultraviolet curable composition (Preparation example 1) is diluted in the dilution agent (cyclohexanone), so that a solution in which solid content thereof becomes 50% by mass, is obtained. A part of 2 mm from the leading end of the base 23 that contacts the intermediate transfer belt is impregnated in the solution and dried by air for three minutes. After drying, ultraviolet rays are irradiated to the part of the base 23 using Ultraviolet irradiation apparatus (UVC-2534/1MNLC3, trade name, produced by Ushio Electric Inc.) at 140 W/cm×5 m/min×5 passes. Next, the same is dried for 15 minutes using a thermal dryer at 100 degrees C. in the dryer. The thus-formed base 23 after surface curing process is secured to a metal mold holder being a support member with an adhesive, so as to obtain a cleaning blades #2 to #4. By changing the impregnation time, the formed cleaning blades #2 to #4 each have a different Martens hardness.

Cleaning Blade #1

2-layer blade, backup layer: polyurethan rubber, JIS-A hardness of 73 degrees; contact layer: polyurethan rubber, JIS-A hardness of 80 degrees;

Martens hardness: 0.8 [N/mm²];

blade thickness: 1.8 [mm]; and

contact linear pressure: 20 [gf/m]

Cleaning Blade #2

Single layer+impregnated layer: polyurethan rubber, JIS-A hardness of 73 degrees+acrylic resin impregnating process;

Martens hardness: 4.5 [N/mm²];

blade thickness: 1.7 [mm]; and

contact linear pressure: 20 [gf/m]

Cleaning Blade #3

Single layer+impregnated layer: polyurethan rubber JIS-A hardness of 73 degrees+acrylic resin impregnating process;

Martens hardness: 5.0 [N/mm²];

blade thickness: 2.0 [mm]; and

contact linear pressure: 20 [gf/m]

Cleaning Blade #4

Single layer+impregnated layer: polyurethan rubber JIS-A hardness of 73 degrees+acrylic resin impregnating process;

Martens hardness: 10 [N/mm²];

blade thickness: 2.0 [mm]; and

contact linear pressure: 20 [gf/m]

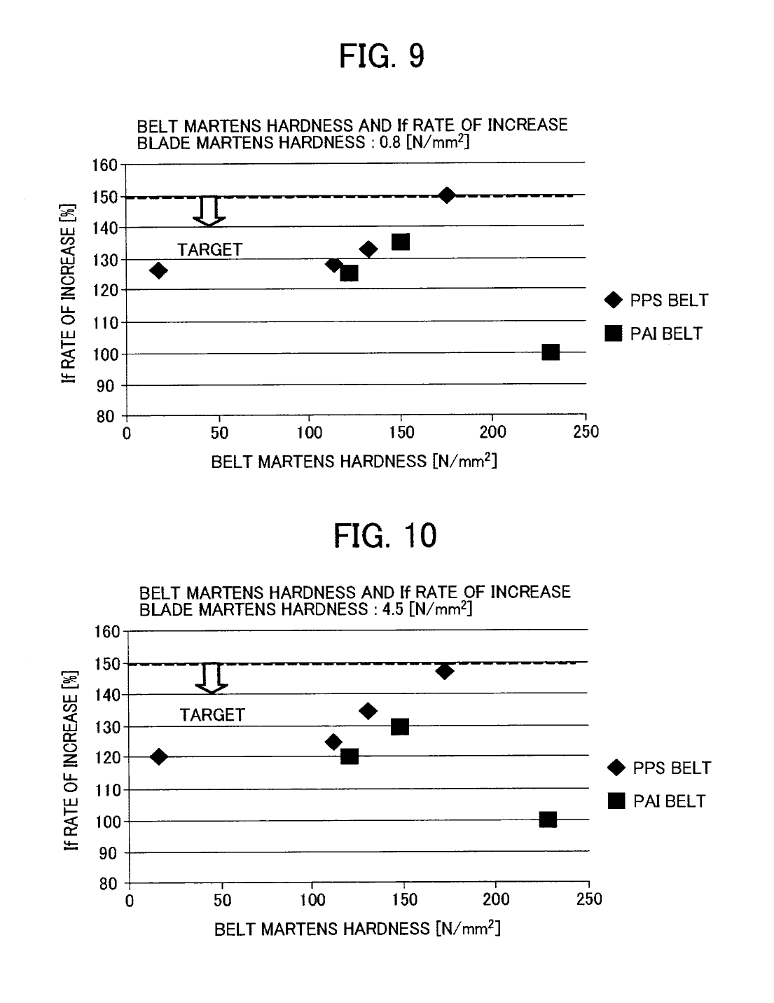

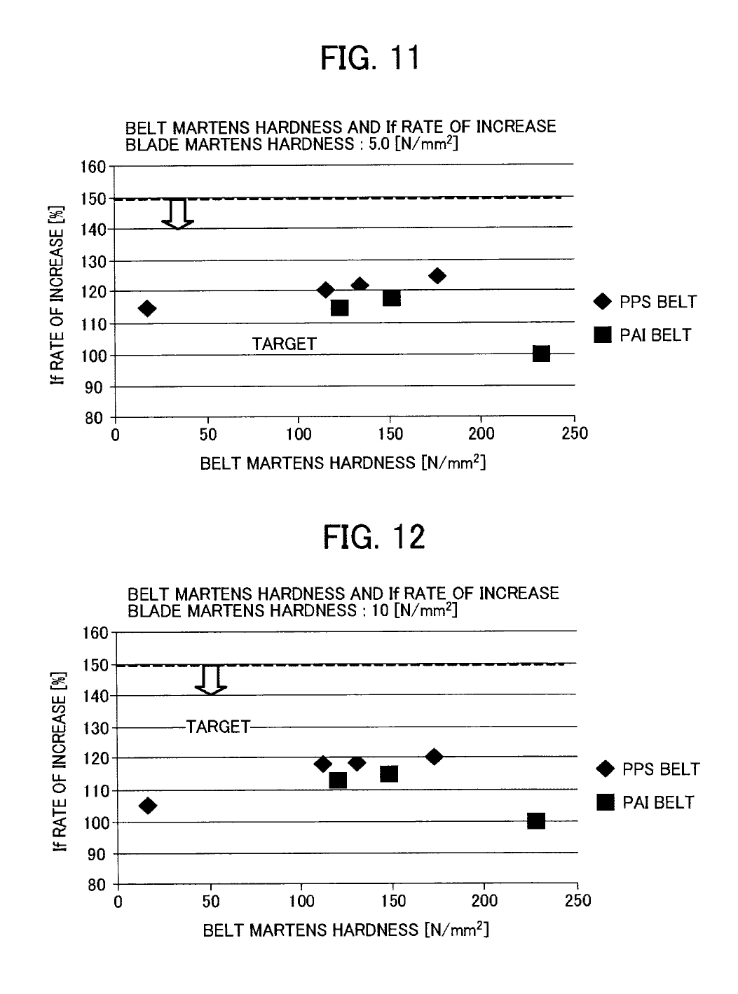

Results of the verification experiments will be shown in FIGS. 9 to 12.

As shown in FIGS. 9 to 12, as Martens hardness of the leading edge of the cleaning blade increases, the If rate of increase is suppressed to low. Possible reasons are as follows: Specifically, the cleaning blade evenly scrapes the intermediate transfer belt to which paper dust (calcium carbonate) sticks. Otherwise, because the blade is prevented from fluctuating in the cleaning nip area as illustrated in FIG. 8(b), the paper dust is unlikely to stick to the intermediate transfer belt. Otherwise, due to the both reasons, the paper dust filming is prevented.

The reason that the cleaning blade 21 can scrape the surface of the belt evenly and thinly is because the If rate of increase decreases as the Martens hardness of the belt increases. However, because the belt is harder than the blade with regard to the values of Martens hardness, it is conceived that the blade 21 scrapes the surface of the belt 3 with additives such as silica adhered around toner as a cleaning auxiliary agent.

The paper dust is unlikely to stick to the intermediate transfer belt as a result that the blade is prevented from fluctuating in the cleaning nip area. It is because the leading edge 22c is impregnated and becomes rigid. Specifically, by making the leading edge 22c rigid, it is thought that the fluctuations of the blade are suppressed, and the frequency in which the paper dust is embedded into the belt in the cleaning nip area is reduced.

Then, as illustrated in FIGS. 9 to 12, in the cleaning blade of which Martens hardness of the leading edge 22c is 0.8 [N/mm2] or more, the If rate of increase of any of the intermediate transfer belt falls on 150% or less. In the image portion to which toner is constantly supplied, If rate of increase of any of the belts stays at 100%, and paper dust filming does not occur in the image portion. Further, no defective cleaning is observed.

### Verification Experiment 2

The verification experiment 2 was performed similarly to the verification experiment 1 except that PPC Paper High White was used as the recording sheet. The experiment was performed using seven intermediate transfer belts each having a different Martens hardness and seven cleaning blades each having a different Martens hardness. The amount of calcium carbonate included in the recording sheet used for the verification experiment 2 was ten times that of the recording sheet used in the verification experiment 1. In the marketplace, paper with a high whiteness degree at low cost may be often used. The recording sheet with a high whiteness includes a lot of calcium carbonate, which is the origin or cause of paper dust filming, so that the verification experiment 2 was performed to clarify that even though the recording sheet with a high calcium carbonate content is used, the Martens hardness of the belt and blade affect filming removal.

Intermediate Transfer Belt #A

Material: PVDF (polyvinylidene fluoride); Martens hardness: 100 [N/mm²];

Thickness: 100 [μm]; Linear speed: 256 [mm/s]; and Tension: 1.3 [N/cm]

Intermediate transfer belt #B

Material: PVDF (polyvinylidene fluoride); Martens hardness: 120 [N/mm²];

Thickness: 100 [μm]; Linear speed: 256 [mm/s]; and Tension: 1.3 [N/cm]

Intermediate transfer belt #C

Material: PPS (polyphenilen sulfide); Martens hardness: 132 [N/mm²]; Thickness: 80 [μm]; Linear speed: 256 [mm/s]; and Tension: 1.3 [N/cm]

Intermediate transfer belt #D

Material: PPS (polyphenilen sulfide); Martens hardness: 175 [N/mm²]; Thickness: 80 [μm]; Linear speed: 256 [mm/s]; and Tension: 1.3 [N/cm]

Intermediate transfer belt #E

Material: PAI (polyamideimide); Martens hardness: 150 [N/mm²]; Thickness: 80 [μm]; Linear speed: 256 [mm/s]; and Tension: 1.3 [N/cm]

Intermediate transfer belt #F

Material: PAI (polyamideimide); Martens hardness: 230 [N/mm²]; Thickness: 80 [μm]; Linear speed: 256 [mm/s]; and Tension: 1.3 [N/cm]

Next, the cleaning blade 21 used for the verification experiment 2 will be described.

The cleaning blade #A was prepared in the similar manner as the cleaning blade #1 was prepared in the verification experiment 1. The cleaning blades #B to #G are cleaning blades to which acrylic resin impregnating process is applied. As to the impregnating process, the above-described preparation example 1 was used for the cleaning blades #B to #G. According to the process as described in the preparation examples 2 to 8, blades with a similar function may be prepared. By changing the impregnation time similarly to the cleaning blades #2 to #4 in the verification experiment 1, the formed cleaning blades #B to #G each have a different Martens hardness.

Cleaning Blade #A

Two-layer blade, Backup layer: polyurethan rubber with JIS-A hardness of 73 degrees, Contact layer: polyurethan rubber with JIS-A hardness of 80 degrees; Martens hardness: 0.8 [N/mm²]; Thickness: 1.8 [mm]; and Contact linear pressure: 20 [gf/cm]

Cleaning Blade #B

Single layer+mixed layer: polyurethan rubber with JIS-A hardness of 73 degrees+acrylic resin impregnating process; Martens hardness: 1.5 [N/mm²]; blade thickness: 2.0 [mm]; and contact linear pressure: 20 [gf/m]

Cleaning Blade #C

Single layer+mixed layer: polyurethan rubber with JIS-A hardness of 73 degrees+acrylic resin impregnating process; Martens hardness: 2 [N/mm²]; blade thickness: 1.8 [mm]; and contact linear pressure: 20 [gf/m]

Cleaning Blade #D

Single layer+mixed layer: polyurethan rubber with JIS-A hardness of 73 degrees+acrylic resin impregnating process; Martens hardness: 3.0 [N/mm²]; blade thickness: 1.8 [mm]; and contact linear pressure: 20 [gf/m]

Cleaning Blade #E

Single layer, Backup layer: polyurethan rubber with JIS-A hardness of 73 degrees+acrylic resin impregnating process; Martens hardness: 4.5 [N/mm²]; blade thickness: 1.8 [mm]; and contact linear pressure: 20 [gf/m]

Cleaning Blade #F

Single layer+mixed layer: polyurethan rubber with JIS-A hardness of 73 degrees+acrylic resin impregnating process; Martens hardness: 5.0 [N/mm²]; blade thickness: 1.8 [mm]; and contact linear pressure: 20 [gf/m]

Cleaning Blade #G

Single layer+mixed layer: polyurethan rubber with JIS-A hardness of 73 degrees+acrylic resin impregnating process; Martens hardness: 10 [N/mm²]; blade thickness: 1.8 [mm]; and contact linear pressure: 20 [gf/m]

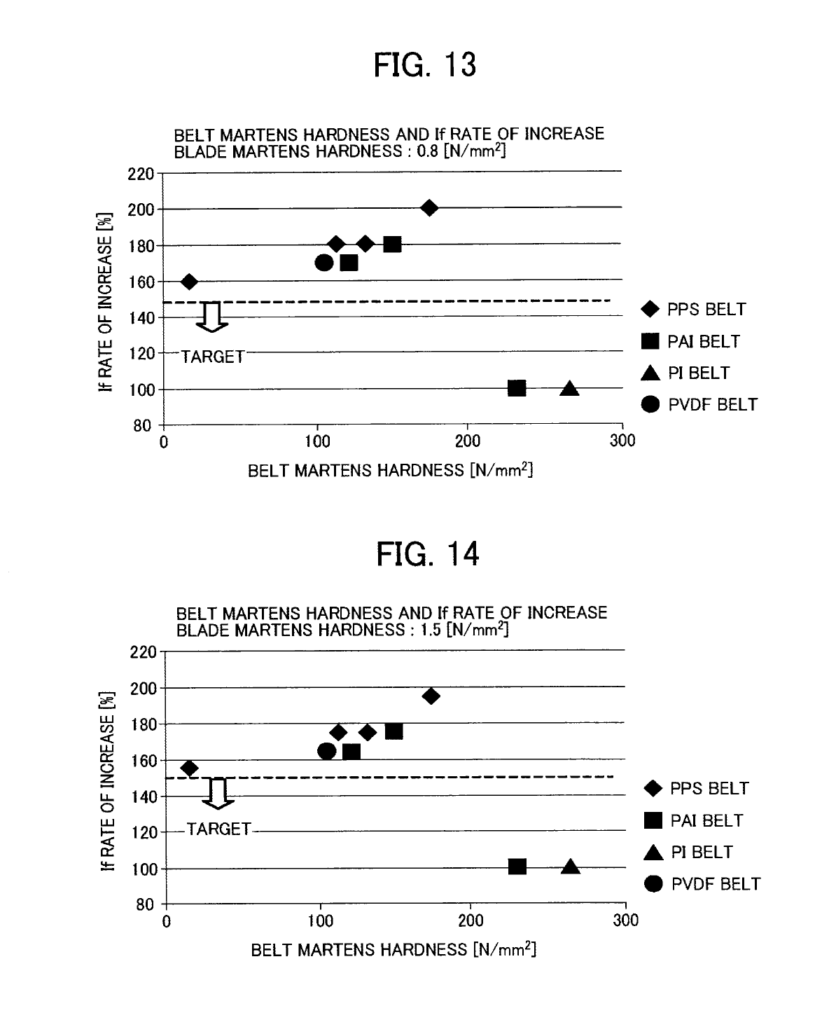

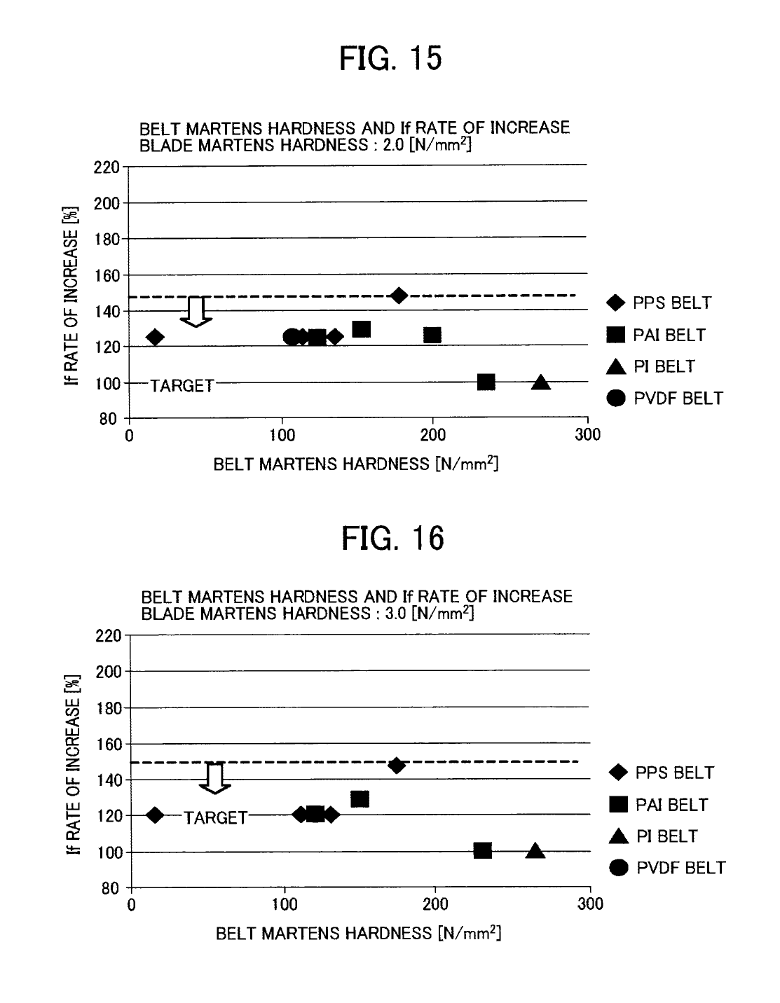

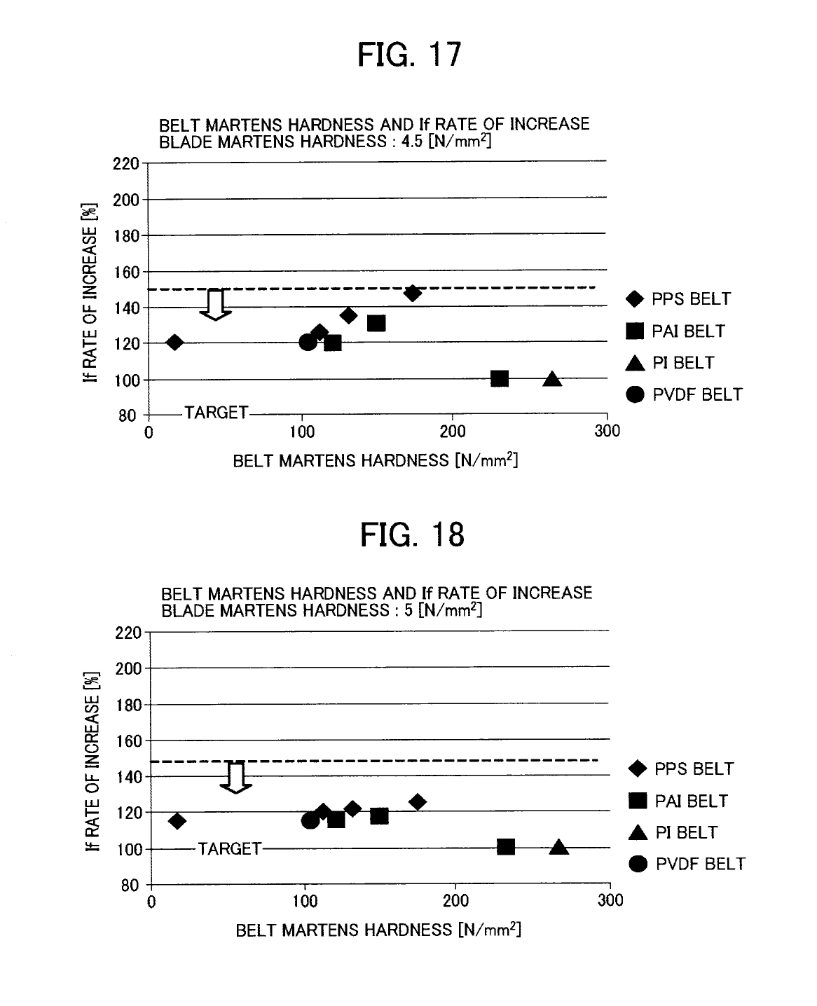

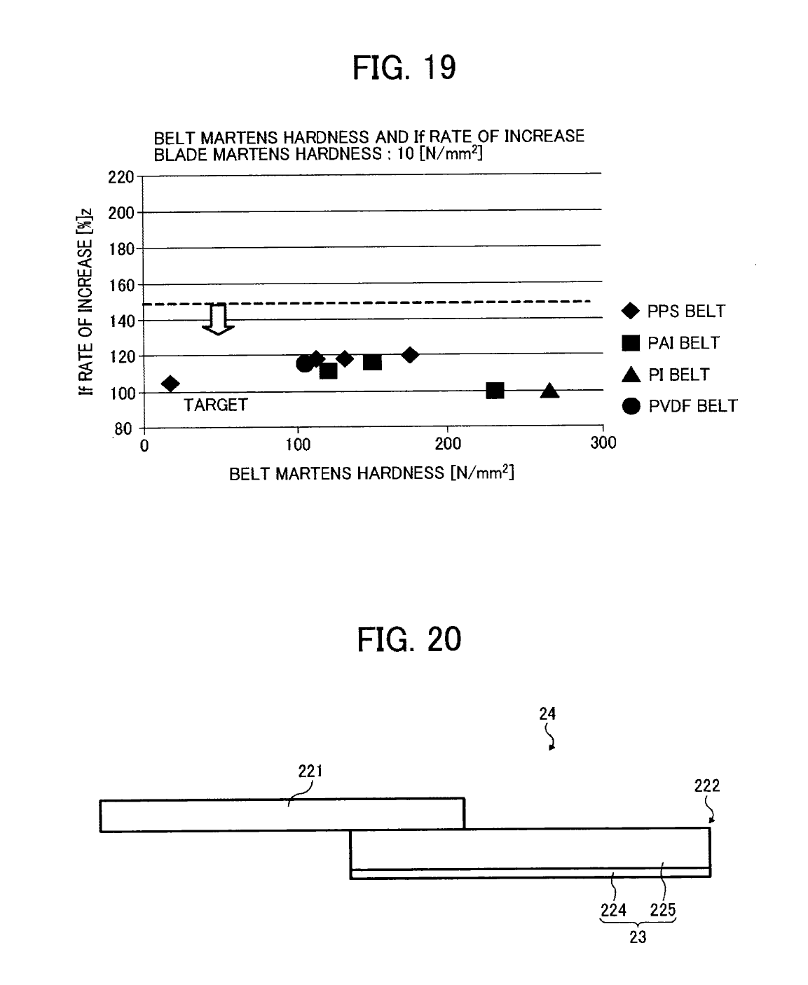

FIGS. 13 to 19 illustrate results of verification experiment 2.

As shown in FIGS. 13 to 19, as Martens hardness of the leading edge 22c of the cleaning blade 21 increases, the If rate of increase is suppressed to low. However, if comparing the verification experiment 1 in which recording sheets with less amount of calcium carbonate are used with the verification experiment 2 that employs recording sheets with greater amount of calcium carbonate, the verification experiment 2 shows worsened If rate of increase. For example, take examples of FIGS. 9 and 13 in which Martens hardness of the leading edge of the cleaning blade is 0.8 [N/mm²]. When the recording sheet with less amount of calcium carbonate, that is, “My Paper” is used, paper dust filming can be suppressed and the If rate of increase becomes 150% or less (see FIG. 9). However, when the recording sheet with greater amount of calcium carbonate is employed, paper dust filming cannot be suppressed and the If rate of increase exceeds 150% (see FIG. 13). In addition, in the verification experiment 2, the cleaning blade #B having Martens hardness of the leading edge 0.8 [N/mm²] causes defective cleaning to occur. Considering that the cleaning blade with Martens hardness of 0.8 [N/mm²] in the verification experiment 1 does not cause a defective cleaning to occur, it is conceived that the defective cleaning occurs due to paper dust film adhered in abundance to the intermediate transfer belt.

In addition, from the results of verification experiment 2, in the cleaning blades #C to #G having the leading edge 22c with Martens hardness of 2.0 [N/mm²] or more, even though the recording sheet including a lot of calcium carbonate is used, the If rate of increase can be suppressed to 150% or less. Further, no defective cleaning is observed.

In addition, when the Martens hardness of the leading edge of the cleaning blade is increased to 10 [N/mm²] or more, it is conceivable that the filming removal effect is further improved. However, if the Martens hardness is increased to high, the following adverse effect is caused. Specifically, when the Martens hardness of the leading end of the blade is increased too much, the blade tip end becomes too hard. When the polyurethan rubber becomes hard in the low temperature and low humidity environment, tracking of the blade tip end relative to the surface of the intermediate transfer belt worsens, so that the defective cleaning may occur. At least from the above verification experiments, when the Martens hardness of the leading edge 22c of the cleaning blade 21 is set to 2 to 10 [N/mm²], paper dust filming and toner cleaning performance can be dealt with collaterally.

In addition, it is proved that from various investigations, the blade is subject to a local friction as the Martens hardness increases. As a result, the Martens hardness of the leading edge 22c of the cleaning blade is preferably suppressed to low to secure a stable lifetime over a long time. Accordingly, it is more preferable that the Martens hardness of the leading edge 22c of the cleaning blade be 2 to 5 [N/mm²]. With this structure, paper dust filming and toner cleaning performance can be dealt with collaterally and a stable lifetime over a long time can be secured. In particular, the Martens hardness 5 [N/mm²] of the leading edge 22c of the cleaning blade should be the optimal value to secure the lifetime of the blade and to remove the paper dust film.

The cleaning blade has been described heretofore, in which the contact portion such as the leading edge 22c includes the impregnated layer 22d containing at least one of acrylic resin and methacrylic resin relative to the base 23 of the blade. Further, as far as the hardness of the leading edge of the cleaning blade is from 2 [N/mm²] to 10 [N/mm²] or less, even though a two-layer structure cleaning blade includes the base 23 made of a low hardness backup layer and a high hardness contact layer of from 2 [N/mm²] to 10 [N/mm²] or less, the same effect can be obtained.

FIG. 20 illustrates a schematic configuration of a two-layer structure cleaning blade 24 including a base 23 that includes a backup layer 225 and a contact layer 224.

The contact layer 224 is made of urethane rubber as an elastic member. The backup layer 225 may be made of urethane rubber as an elastic member, or any resins with an elasticity. The Martens hardness of the contact layer 224 is appropriately higher than that of the backup layer 225. After the contact layer 224 alone is molded into a sheet shape, the Martens hardness thereof is set to a range from 2 [N/mm²] to 10 [N/mm²] or less. With this structure, the Martens hardness of the leading edge of the cleaning blade is set to 2 [N/mm²] or more, and 10 [N/mm²] or less. In addition, properties of the contact layer 224 and the backup layer 225 may be changed depending on the type of toner or the speed of the intermediate transfer belt 3. The thickness of the contact layer 224 is 0.5 mm, and that of the backup layer 225 1.3 mm. A ratio of the thicknesses between the both is variable depending on the selection of the rubber hardness.

In the cleaning blade 24 as illustrated in FIG. 20, the backup layer 225 includes a lower hardness than the contact layer does, so that the collapse of the cleaning blade 24 due to a long-term use and lowering of contact pressure can be prevented. Thus, an optimal cleaning performance can be obtained over a long time. Compared to the cleaning blade produced by the impregnation process, the cleaning blade 24 can be produced with a simplified process, so that a low cost is achieved.

The embodiments described above are examples, and each aspect of the present invention exerts particular effects.

<Aspect 1>

An intermediate transfer belt 3 conveys a toner image transferred from an image carrier such as a photoreceptor, to a transfer section such as a secondary transfer roller 17 that transfers the toner image to a recording sheet P. A cleaning blade 21, including a contact portion, cleans a surface of the intermediate transfer belt 3 by contacting, with the contact portion, the surface of the intermediate transfer belt 3, and a Martens hardness of the contact portion (that is, a leading edge 22c, in the present embodiment) with the intermediate transfer belt 3 is 2 [N/mm²] or more and 10 [N/mm²] or less.

According to Aspect 1, as described in the verification experiment, the Martens hardness of the contact portion of the cleaning blade to contact the intermediate transfer belt is made at least 2 [N/mm²] and not more than 10 [N/mm²], so that paper dust formed mainly of calcium carbonate stuck on the surface of the belt material can be removed by the cleaning blade. With this structure, paper dust filming can be prevented from occurring to the belt member.

<Aspect 2>

In Aspect 1, the contact portion such as the leading edge 22c includes an impregnated layer 22d impregnated with at least one of acrylic resins and methacrylic resins, relative to a base 23 of the blade.

With such a structure, the Martens hardness of the leading edge 22c of the cleaning blade is made at least 2 [N/mm²] and not more than 10 [N/mm²] with the acrylic resins or methacrylic resins.

In addition, use of the acrylic resins and methacrylic resins may improve durability of the cleaning blade compared to the use of silicon-containing cross-linked resins. Further, compared to a case in which a surface layer is formed, of which hardness of the contact portion such as the leading edge 22c is increased, the sudden change in the hardness at the boundary between the high hardness layer and the base layer can be restricted, thereby preventing the blade member 222 from being damaged due to a concentrated stress.

<Aspect 3>

In Aspect 1, the cleaning blade is formed into a layered structure including a contact layer 224 that includes a contact portion such as a leading edge, and a backup layer 225 with a hardness lower than that of the contact layer 224.

With this structure, as described referring to FIG. 20, because the backup layer 225 includes a lower hardness than the contact layer does, so that the collapse of the cleaning blade 24 due to a long-term use and lowering of contact pressure can be prevented. In addition, compared to the cleaning blade produced by the impregnation process of the contact portion such as the leading edge to make it harder, the cleaning blade 24 can be produced with a simplified process, so that a low cost is achieved.

<Aspect 4>

In an image forming apparatus such as a printer 30 including an image carrier such as a photoreceptor; a toner image forming unit to form a toner image on the image carrier, specifically including a charger 8, an exposure device 9, and a developing device 10 in the present embodiments); a primary transfer unit such as a primary transfer roller to primarily transfer the toner image formed on the image carrier to the intermediate transfer belt 3; a secondary transfer unit such as a secondary transfer roller 17 to transfer the toner image carried on the intermediate transfer belt 3, to a recording sheet P; and a cleaning blade 21 to clean a surface of the intermediate transfer belt 3, a cleaning blade according to any of Aspect 1 to Aspect 3 is used.

With such a structure, the paper dust filming of the intermediate transfer belt 3 can be prevented over a long time.

<Aspect 5>

In Aspect 4, the Martens hardness of the intermediate transfer belt is 200 [N/mm²] or less.

The paper dust filming occurs to the intermediate transfer belt 3 in general, and the cleaning blade as described in any of Aspect 1 to Aspect 3 is employed as a cleaning blade to clean the surface of the intermediate transfer belt 3 with a Martens hardness of 200 [N/mm²] or less, thereby optimally preventing the paper dust filing.

<Aspect 6>

In Aspect 4 or 5, the intermediate transfer belt is an extrusion-molded intermediate transfer belt.

With such a structure, compared to a case of using a centrifugal molding process, the intermediate transfer belt can be produced at a low cost, thereby minimizing a cost rise of the apparatus.

<Aspect 7>

In either Aspect 4 to 6, an optical sensor 13 to detect an amount of toner adhering to the intermediate transfer belt 3 is disposed.

According to Aspect 7, the paper dust filming of the intermediate transfer belt 3 is prevented, and therefore, the amount of toner adhering to the intermediate transfer belt 3 can be optimally detected over a long time.

Additional modifications and variations of the present invention are possible in light of the above teachings. It is therefore to be understood that, within the scope of the appended claims, the invention may be practiced other than as specifically described herein.

What is claimed is:

1. A cleaning blade for an image forming apparatus, comprising:
a base; and
a contact portion disposed on the base that contacts and cleans a surface of an intermediate transfer belt of the image forming apparatus,
wherein a Martens hardness of the contact portion of the cleaning blade is at least 2 [N/mm²] and not more than 10 [N/mm²].

2. The cleaning blade as claimed in claim 1, wherein the contact portion of the cleaning blade includes a layer containing at least one of acrylic resin and methacrylic resin.

3. The cleaning blade as claimed in claim 1, further comprising:
a layered structure including a contact layer including a contact portion, and a backup layer,
wherein the backup layer and the contact layer are laminated in layers, and the backup layer includes a lower hardness than the contact layer does.

4. An image forming apparatus comprising:
an image carrier;
an intermediate transfer belt;
a toner image forming unit to form a toner image on the image carrier;
a primary transfer unit to transfer the toner image formed on the image carrier to the intermediate transfer belt;
a secondary transfer unit to transfer the toner image carried on the intermediate transfer belt to a recording sheet; and
a cleaning blade including a base and a contact portion disposed on the base that contacts and cleans a surface of the intermediate transfer belt,
wherein a Martens hardness of the contact portion of the cleaning blade is at least 2 [N/mm²] and not more than 10 [N/mm²].

5. The image forming apparatus as claimed in claim 4, wherein a Martens hardness of the intermediate transfer belt is 200[N/mm²] or less.

6. The image forming apparatus as claimed in claim 4, wherein the intermediate transfer belt is an extrusion-molded intermediate transfer belt.

7. The image forming apparatus as claimed in claim 4, further comprising an optical sensor to detect an amount of toner adhering to the intermediate transfer belt.
